(19) United States
(12) Patent Application Publication
(10) Pub. No.: US 2025/0349039 A1
(43) Pub. Date: Nov. 13, 2025

(54) IMAGE PROCESSING METHOD AND APPARATUS, COMPUTER DEVICE, AND STORAGE MEDIUM

(71) Applicant: Tencent Technology (Shenzhen) Company Limited, Shenzhen (CN)

(72) Inventor: Xiang PAN, Shenzhen (CN)

(21) Appl. No.: 19/270,193

(22) Filed: Jul. 15, 2025

Related U.S. Application Data
(63) Continuation of application No. PCT/CN2024/094474, filed on May 21, 2024.

(30) Foreign Application Priority Data
May 24, 2023 (CN) 202310600970.4

(51) Int. Cl. G06T 9/00

(52) U.S. Cl. CPC G06T 9/002

(57) ABSTRACT

Embodiments of this application provide an image processing method performed by a computer device. The method includes: obtaining a bit stream of an image; extracting, from the bit stream, decoding indication information, the decoding indication information indicating a decoding operation to be performed in a decoding neural network, and invoking, based on the decoding indication information, a decoding neural network to perform the decoding operation on the bit stream to reconstruct the image, wherein the decoding operation is configured for performing grouping on a convolution operation in at least one convolutional layer in the decoding neural network. The embodiments of this application can reduce decoding complexity on a decoder side, thereby improving decoding efficiency.

### CROSS-REFERENCE TO RELATED APPLICATIONS

This application is a continuation application of PCT Patent Application No. PCT/CN2024/094474, entitled “IMAGE PROCESSING METHOD AND APPARATUS, COMPUTER DEVICE, AND STORAGE MEDIUM” filed on May 21, 2024, which claims priority to Chinese Patent Application No. 2023106009704, entitled “IMAGE PROCESSING METHOD AND RELATED DEVICE” filed on May 24, 2023, both of which are incorporated herein by reference in their entirety.

### FIELD OF THE TECHNOLOGY

This application relates to the field of image processing technologies, and in particular, to an image processing method, an image processing apparatus, a computer device, and a non-transitory computer-readable storage medium.

### BACKGROUND OF THE DISCLOSURE

In a neural network model for end-to-end image compression, an encoder side maps an original image to a hidden variable through an analysis transform net, and writes the hidden variable to a bit stream through an entropy encoder. A decoder side decodes the bit stream through an entropy decoder to obtain the hidden variable, and then inputs the hidden variable to a synthesis transform net to obtain a reconstructed image. However, the current image encoding/decoding solution has problems such as relatively high decoding complexity, low decoding efficiency, and therefore cannot be well supported by a mobile device.

### SUMMARY

Embodiments of this application provide an image processing method and a related device, which can reduce decoding complexity on a decoder side, thereby improving decoding efficiency.

According to an aspect, an embodiment of this application provides an image processing method. The method includes:
obtaining a bit stream of an image;
extracting, from the bit stream, decoding indication information, the decoding indication information indicating a decoding operation to be performed in a decoding neural network, and
invoking, based on the decoding indication information, a decoding neural network to perform the decoding operation on the bit stream to reconstruct the image, wherein the decoding operation is configured for performing grouping on a convolution operation in at least one convolutional layer in the decoding neural network.

According to an aspect, an embodiment of this application provides a computer device. The computer device includes:
a processor, configured to execute a computer program; and
a computer-readable storage medium, having a computer program stored therein, the computer program, when executed by the processor, causing the computer device to implement the above image processing method.

According to an aspect, an embodiment of this application provides a non-transitory computer-readable storage medium, having a computer program stored therein, the computer program being loaded and executed by a processor of a computer device and causing the computer device to implement the above image processing method.

In the embodiments of this application, the bit stream of the image formed after encoding processing is obtained, and the decoding indication information is obtained, the decoding indication information being configured for indicating the decoding operation to be performed in the decoding neural network; and then the decoding neural network is invoked based on the decoding indication information to perform decoding processing on the bit stream, to reconstruct the image. During the decoding of the image, the indication of the decoding indication information can simplify a decoding operation in the decoding neural network on a decoder side, which can effectively reduce decoding complexity on the decoder side, thereby improving decoding efficiency.

### BRIEF DESCRIPTION OF THE DRAWINGS

To describe technical solutions in embodiments of this application or in the related art more clearly, drawings required for describing the embodiments or the prior art are briefly described below. Apparently, the drawings in the following description show only some of the embodiments of this application, and a person of ordinary skill in the art may derive other drawings from these drawings without creative efforts.

FIG. 1A is a structural diagram of an end-to-end image encoding model based on deep learning according to an exemplary embodiment of this application.

FIG. 1B is a structural diagram of an end-to-end image encoding model based on deep learning according to another exemplary embodiment of this application.

FIG. 2A is a schematic diagram of comparison between network structures of a synthesis transform net and a light weighted synthesis transform net for processing a chrominance component and a luminance component according to an exemplary embodiment of this application.

FIG. 2B is a schematic diagram of comparison between structures of a residual block and a light weighted residual block according to an exemplary embodiment of this application.

FIG. 2C is a schematic diagram of comparison between network structures of a hyper decoder net and a light weighted hyper decoder net for processing a chrominance component and a luminance component according to an exemplary embodiment of this application.

FIG. 2D is a schematic diagram of comparison between network structures of a hyper scale decoder net and a light weighted hyper scale decoder net for processing a chrominance component and a luminance component according to an exemplary embodiment of this application.

FIG. 2E is a schematic diagram of comparison between a conventional convolution operation and a group convolution operation according to an exemplary embodiment of this application.

FIG. 2F is a schematic diagram of channel reconstruction according to an exemplary embodiment of this application.

FIG. 3 is an architecture diagram of an image processing system according to an exemplary embodiment of this application.

FIG. 4 is a schematic flowchart of an image processing method according to an exemplary embodiment of this application.

FIG. 5 is a schematic flowchart of an image processing method according to another exemplary embodiment of this application.

FIG. 6 is a schematic structural diagram of an image processing apparatus according to an exemplary embodiment of the embodiments of this application.

FIG. 7 is a schematic structural diagram of an image processing apparatus according to another exemplary embodiment of the embodiments of this application.

FIG. 8 is a schematic structural diagram of a computer device according to an exemplary embodiment of the embodiments of this application.

### DESCRIPTION OF EMBODIMENTS

Technical solutions in embodiments of this application are clearly and completely described below with reference to drawings in the embodiments of this application. Apparently, the described embodiments are merely some embodiments rather than all the embodiments of this application. All other embodiments obtained by a person of ordinary skill in the art based on the embodiments of this application without creative efforts fall within the protection scope of this application.

Related technical terms involved in this application are first described.

### 1. Image

An image may refer to a to-be-encoded image. The image may be any one or more frames in a video. A pixel format of the image may be RGB or YUV. When the pixel format of the image is RGB, the image may include a red (R) component, a green (G) component, and a blue (B) component. When the pixel format of the image is YUV, the image may include a luminance (Y) component and a chrominance (UV) component.

### 2. End-to-End Image Encoding Model Based on Deep Learning

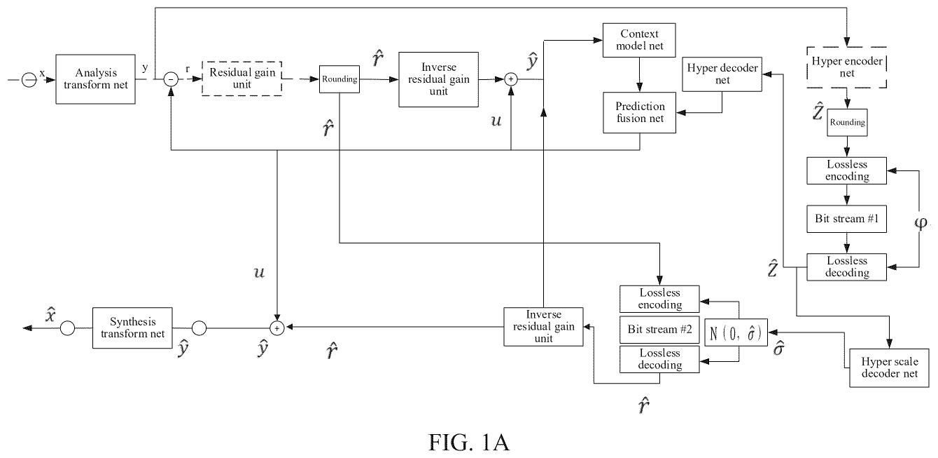

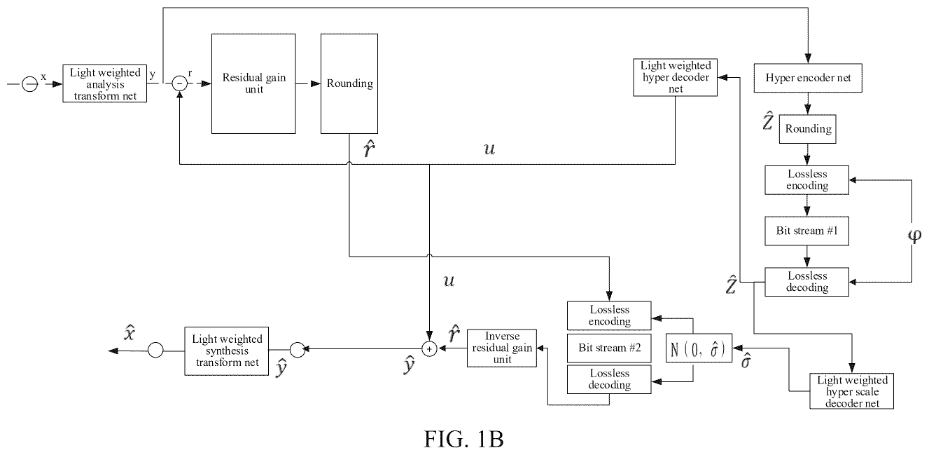

The embodiments of this application involve an end-to-end image encoding model based on deep learning. Exemplarily, the end-to-end image encoding model based on deep learning may be applied to a joint photographic experts group (JPEG) artificial intelligence (AI) platform. Exemplarily, the end-to-end image encoding model based on deep learning may be a verification model (VM). FIG. 1A is a structural diagram of an end-to-end image encoding model based on deep learning according to an exemplary embodiment of this application. The end-to-end image encoding model based on deep learning adopts a transform-encoding structure. The end-to-end image encoding model based on deep learning mainly includes an analysis transform net, a context model net, a hyper encoder net, a prediction fusion net, a hyper decoder net, a hyper scale decoder net, and a synthesis transform net. Next, the foregoing nets are described in detail.

### \textcircled{1}. Analysis Transform Net

The analysis transform net is configured to perform nonlinear transformation on a to-be-encoded image x, to obtain a transformation result y (or referred to as a hidden variable) of the image x. Exemplarily, when the image x includes a luminance component x_{Y} and a chrominance component x_{UV}, the analysis transform net may perform nonlinear transformation on the luminance component x_{Y} and the chrominance component x_{UV} respectively, to obtain a transformation result y_{Y} corresponding to the luminance component x_{Y} and a transformation result y_{UV} corresponding to the chrominance component x_{UV}.

\textcircled{2}. Context model net

The context model net is configured to perform context processing on a transformation value ŷ of the image x. Output data of the context model net is used as an input of the prediction fusion net. The transformation value ŷ of the image x is obtained through superposition of a predicted value u of the image x outputted by the prediction fusion net and data outputted after passing through an inverse residual gain unit (inverse Gain unit residual, invG unitRes). Input data of the inverse gain unit residual is an image residual \hat{r} of the image x. The image residual \hat{r} may be obtained through quantization processing on data outputted by a residual gain unit (Gain unit residual, G unitRes). Specifically, a type of the data outputted by the residual gain unit is a floating-point type. The quantization processing includes data type conversion processing (that is, rounding processing). Rounding processing is performed on the data outputted by the residual gain unit, to obtain an integer image residual \hat{r}, to generate a bit stream. Input data of the residual gain unit is a residual r obtained through a difference operation on the transformation result y of the image x obtained by the analysis transform net and the predicted value u outputted by the prediction fusion net.

When the image x includes the luminance component x_{Y} and the chrominance component x_{UY}, a residual r_{Y} of the luminance component may be obtained through a difference operation on the transformation value y_{Y} of the luminance component x_{Y} and a predicted value u_{Y} of the luminance component outputted by the prediction fusion net, and a residual r_{UV} of the chrominance component may be obtained through a difference operation on the transformation value y_{UV} of the chrominance component x_{UY} and a predicted value u_{UV} of the chrominance component outputted by the prediction fusion net. Then quantization processing is performed on r_{Y} and r_{UV} to convert them into integers \hat{r}_{Y} and \hat{r}_{UV}, and operations are performed to generate a bit stream.

\textcircled{3}. The prediction fusion net is configured to perform prediction on the image x, to obtain the predicted value u of the image x. Input data of the prediction fusion net is the output data of the context model net and output data of the hyper decoder net. Exemplarily, the prediction fusion net is configured to perform prediction on the chrominance component and the luminance component of the image, to obtain the predicted value u, including the predicted value u_{Y} of the luminance component and the predicted value u_{UV} of the chrominance component.
\textcircled{4}. The hyper encoder net is configured to process the transformation result y of the image x, then perform quantization processing on output data of the hyper encoder net to obtain a quantization result of the image, and perform lossless encoding on the quantization result, to obtain a bit stream. The quantization processing includes rounding processing. In this case, performing quantization processing on the output data of the hyper encoder net to obtain the quantization result of the image may include: performing rounding processing on the output data of the hyper encoder net to obtain the quantization result of the image.
\textcircled{5}. Input data of the hyper decoder net is a hyper parameter \hat{Z} obtained based on the bit stream, and the output data of the hyper decoder net is used as the input data of the prediction fusion net.
\textcircled{6}. The hyper scale decoder net is configured to determine a Gaussian distribution N(0,\hat{σ}) with an average value of 0 and a variance of \hat{σ} based on the hyper parameter \hat{Z}. The synthesis transform net is configured to perform synthesis transform processing on the transformation value ŷ decoded from the bit stream to reconstruct the image ŷ. Exemplarily, the synthesis transform net is configured to perform synthesis transform processing on the transformation value ŷ_{Y} of the luminance component of the transformation value ŷ decoded from the bit stream and on the transformation value ŷ_{UV} of the chrominance component of the transformation value ŷ decoded from the bit stream, to obtain the luminance component [symbol] and the chrominance component \hat{x}_{UV} of the reconstructed image, thereby obtaining the reconstructed image \hat{x}.

In addition, the end-to-end image encoding model based on deep learning may alternatively be a light weighted VM model. FIG. 1B is a structural diagram of an end-to-end image encoding model based on deep learning according to another exemplary embodiment of this application. As shown in FIG. 1B, the end-to-end image encoding model based on deep learning mainly includes a light weighted analysis transform net, a hyper encoder net, a light weighted hyper decoder net, a light weighted hyper scale decoder net, and a light weighted synthesis transform net.

The light weighted analysis transform net may have the same function as the analysis transform net, but has lower complexity than the analysis transform net. The light weighted hyper decoder net may have the same function as the hyper decoder net, but has lower complexity than the hyper decoder net. The light weighted hyper scale decoder net may have the same function as hyper scale decoder net, but has lower complexity than the hyper scale decoder net. The light weighted synthesis transform net may have the same function as the synthesis transform net, but has lower complexity than the synthesis transform net.

Next, network structures of nets corresponding to FIG. 1A and FIG. 1B are exemplarily compared.

(1). A network structure of the synthesis transform net is compared with a network structure of the light weighted synthesis transform net.

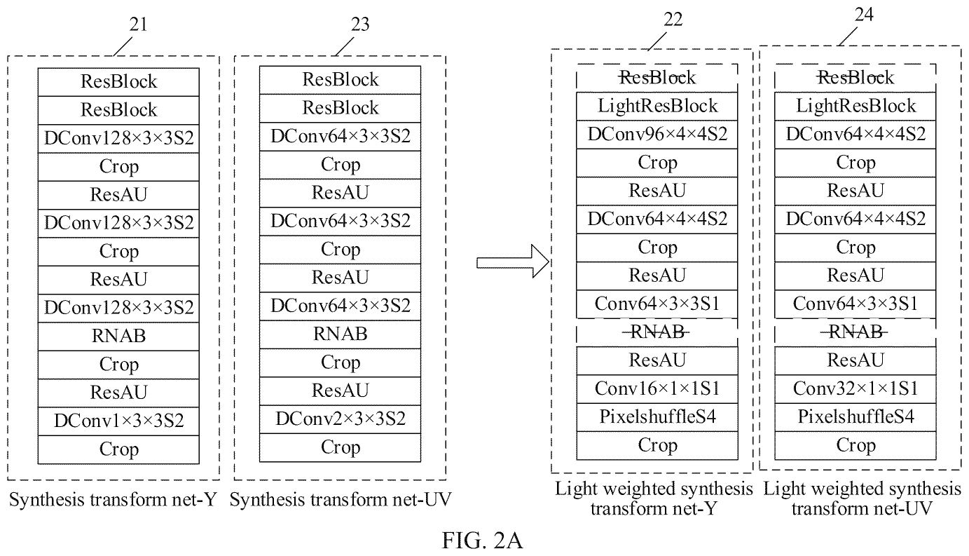

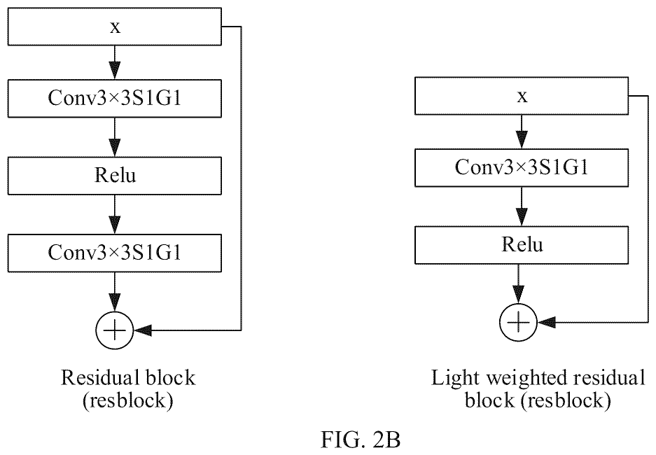

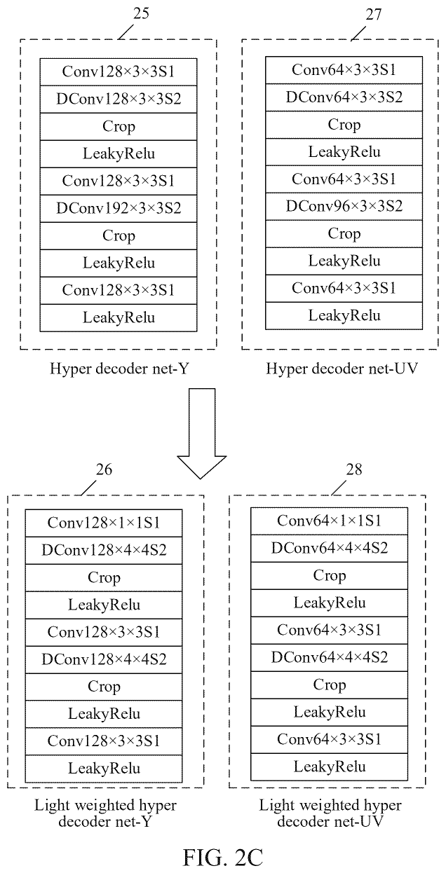

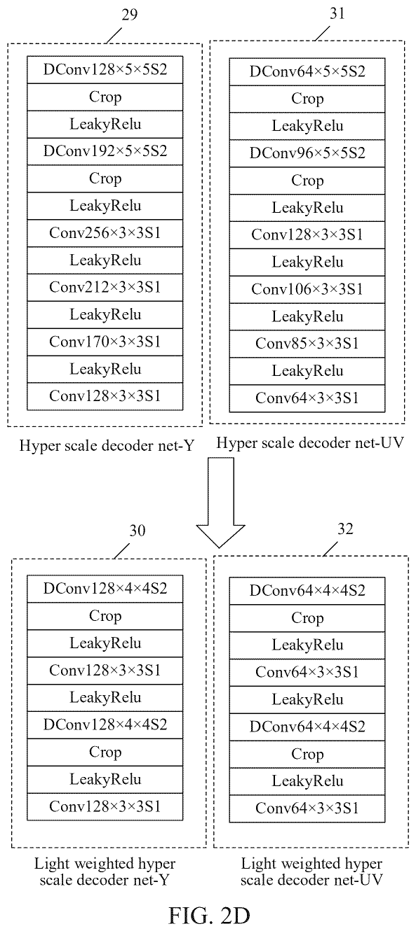

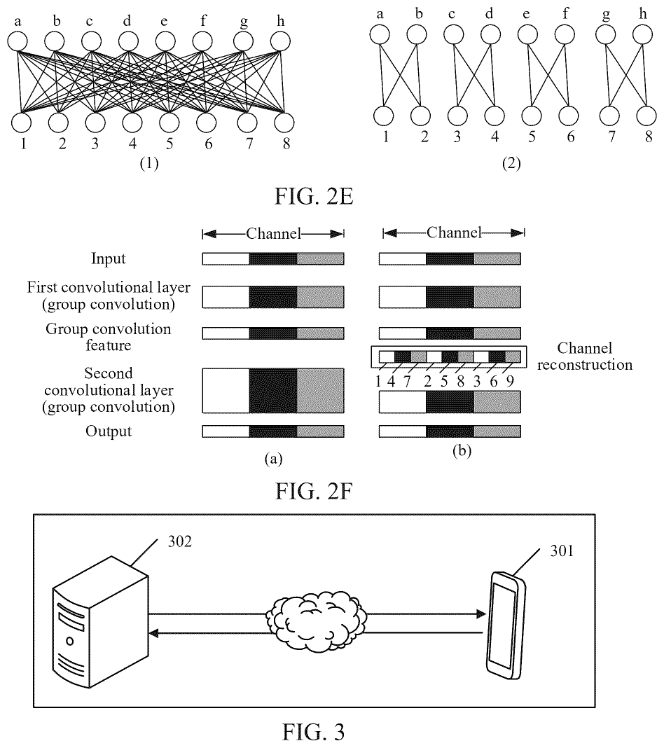

The synthesis transform net may be configured to perform synthesis transform processing on a transformation value of a luminance component and a transformation value of a chrominance component of an image. The light weighted synthesis transform net may be configured to perform synthesis transform processing on a transformation value of a luminance component and a transformation value of a chrominance component of an image. FIG. 2A is a schematic diagram of comparison between network structures of a synthesis transform net and a light weighted synthesis transform net for processing a chrominance component and a luminance component according to an exemplary embodiment of this application.

\textcircled{1}. Comparison between a network structure of a synthesis transform net (Synthesis Transform Net_Y) for processing a luminance component and a network structure of a light weighted synthesis transform net (Light weighted Synthesis Transform Net_Y) for processing the luminance component.

As shown by 21 in FIG. 2A, to process the luminance component, the synthesis transform net mainly includes two residual blocks (ResBlock), four convolutional layers, four crop layers (Crop), three residual nonlinear units (ResAU), and an attention module (a residual non-local attention block, RNAB). The four convolutional layers from top to bottom are sequentially as follows: DConv128×3×3S2 (DConv represents deconvolution, a channel quantity is 128, a convolution kernel size is 3×3, and S2 represents a convolution step of 2), DConv128×3×3S2 (DConv represents deconvolution, a channel quantity is 128, a convolution kernel size is 3×3, and S2 represents a convolution step of 2), DConv128×3×3S2 (DConv represents deconvolution, a channel quantity is 128, a convolution kernel size is 3×3, and S2 represents a convolution step of 2), and DConv1×3×3S2 (DConv represents deconvolution, a channel quantity is 1, a convolution kernel size is 3×3, and S2 represents a convolution step of 2).

As shown by 22 in FIG. 2A, to process the luminance component, the light weighted synthesis transform net mainly includes one light weighted residual block (LightResBlock), four convolutional layers, three crop layers (Crop), three residual nonlinear units (ResAU), and one pixel shuffle (pixelshuffleS4). The four convolutional layers from top to bottom are sequentially as follows: DConv96×4×4S2 (DConv represents deconvolution, a channel quantity is 96, a convolution kernel size is 4×4, and S2 represents a convolution step of 2), DConv64×4×4S2 (DConv represents deconvolution, a channel quantity is 64, a convolution kernel size is 4×4, and S2 represents a convolution step of 2), Conv64×3×3S1 (Conv represents convolution, a channel quantity is 64, a convolution kernel size is 3×3, and S1 represents a convolution step of 1), and Conv16×1×1S1 (Conv represents convolution, a channel quantity is 16, a convolution kernel size is 1×1, and S1 represents a convolution step of 1).

It may be learned from the comparison between 21 and 22 in FIG. 2A that, to process the luminance component, the network structure of the light weighted synthesis transform net needs only one light weighted residual block and does not need a RNAB, while the synthesis transform net needs two residual blocks and needs a RNAB. In addition, network parameters in the convolutional layers of the light weighted synthesis transform net and the synthesis transform net are different. It may be learned that the network structure of the light weighted synthesis transform net has lower complexity than that of the synthesis transform net.

\textcircled{2}. Comparison between a network structure of a synthesis transform net (Synthesis Transform Net_UV) for processing a chrominance component and a network structure of a light weighted synthesis transform net (Light weighted Synthesis Transform Net_UV) for processing the chrominance component.

As shown by 23 in FIG. 2A, to process the chrominance component, the synthesis transform net mainly includes two residual blocks (ResBlock), four convolutional layers, four crop layers (Crop), three residual nonlinear units (ResAU), and an attention module (an RNAB). The four convolutional layers from top to bottom are sequentially as follows: DConv64×3×3S2 (DConv represents deconvolution, a channel quantity is 64, a convolution kernel size is 3×3, and S2 represents a convolution step of 2), DConv64×3×3S2 (DConv represents deconvolution, a channel quantity is 64, a convolution kernel size is 3×3, and S2 represents a convolution step of 2), DConv64×3×3S2 (DConv represents deconvolution, a channel quantity is 64, a convolution kernel size is 3×3, and S2 represents a convolution step of 2), and DConv2×3×3S2 (DConv represents deconvolution, a channel quantity is 2, a convolution kernel size is 3×3, and S2 represents a convolution step of 2).

As shown by 24 in FIG. 2A, to process the chrominance component, the light weighted synthesis transform net mainly includes one light weighted residual block (LightResBlock), four convolutional layers, three crop layers (Crop), three residual nonlinear units (ResAU), and one pixel shuffle (pixelshuffleS4). The four convolutional layers from top to bottom are sequentially as follows: DConv64×4×4S2 (DConv represents deconvolution, a channel quantity is 64, a convolution kernel size is 4×4, and S2 represents a convolution step of 2), DConv64×4×4S2 (DConv represents deconvolution, a channel quantity is 64, a convolution kernel size is 4×4, and S2 represents a convolution step of 2), Conv64×3×3S1 (Conv represents convolution, a channel quantity is 64, a convolution kernel size is 3×3, and S1 represents a convolution step of 1), and Conv32×1×1S1 (Conv represents convolution, a channel quantity is 32, a convolution kernel size is 1×1, and S1 represents a convolution step of 1).

It may be learned from the comparison between 23 and 24 in FIG. 2A that, to process the chrominance component, the network structure of the light weighted synthesis transform net needs only one light weighted residual block and does not need a RNAB, while the synthesis transform net needs two residual blocks and needs a RNAB. In addition, network parameters in the convolutional layers of the light weighted synthesis transform net and the synthesis transform net are different. It may be learned that the network structure of the light weighted synthesis transform net has lower complexity than that of the synthesis transform net.

A structure of the residual block and a structure of the light weighted residual block have a difference. FIG. 2B is a schematic diagram of comparison between structures of a residual block and a light weighted residual block according to an exemplary embodiment of this application. In FIG. 2B, the residual block may include an input layer (for example, an input image x), two convolutional layers (Conv3×3S1G1 and Conv3×3S1G1, a channel quantity being 3×3, S1 representing a step of 1, and G1 representing a quantity of groups during a convolution operation of 1), and an activation function (Relu). The light weighted residual block includes an input layer (for example, an input image x), one convolutional layer (Conv3×3S1G1), and an activation function. It may be learned that structure of the light weighted residual block has lower complexity than that of the residual block.

(2). A network structure of the hyper decoder net is compared with a network structure of the light weighted hyper decoder net.

FIG. 2C is a schematic diagram of comparison between network structures of a hyper decoder net and a light weighted hyper decoder net for processing a chrominance component and a luminance component according to an exemplary embodiment of this application.

\textcircled{1}. Comparison between a network structure of a hyper decoder net (Hyper Decoder_Y) for processing a luminance component and a network structure of a light weighted hyper decoder net (Light weighted Hyper Decoder_Y) for processing the luminance component.

As shown by FIG. 25 in FIG. 2C, to process the luminance component, the hyper decoder net mainly includes five convolutional layers, two crop layers (Crop), and three activation functions (LeakyRelu). The five convolutional layers from top to bottom are sequentially as follows: Conv128×3×3S1 (Conv represents convolution, a channel quantity is 128, a convolution kernel size is 3×3, and S1 represents a convolution step of 1), DConv128×3×3S2 (DConv represents deconvolution, a channel quantity is 128, a convolution kernel size is 3×3, and S2 represents a convolution step of 2), Conv128×3×3S1 (Conv represents convolution, a channel quantity is 128, a convolution kernel size is 3×3, and S1 represents a convolution step of 1), DConv192×3×3S2 (DConv represents deconvolution, a channel quantity is 192, a convolution kernel size is 3×3, and S2 represents a convolution step of 2), and Conv128×3×3S1 (Conv represents convolution, a channel quantity is 128, a convolution kernel size is 3×3, and S1 represents a convolution step of 1).

As shown by FIG. 26 in FIG. 2C, to process the luminance component, the light weighted hyper decoder net mainly includes five convolutional layers, two crop layers (Crop), and three activation functions (LeakyRelu). The five convolutional layers from top to bottom are sequentially as follows: Conv128×1×1S1 (Conv represents convolution, a channel quantity is 128, a convolution kernel size is 1×1, and S1 represents a convolution step of 1), DConv128×4×4S2 (DConv represents deconvolution, a channel quantity is 128, a convolution kernel size is 4×4, and S2 represents a convolution step of 2), Conv128×3×3S1 (Conv represents convolution, a channel quantity is 128, a convolution kernel size is 3×3, and S1 represents a convolution step of 1), DConv128×4×4S2 (DConv represents deconvolution, a channel quantity is 128, a convolution kernel size is 4×4, and S2 represents a convolution step of 2), and Conv128×3×3S1 (Conv represents convolution, a channel quantity is 128, a convolution kernel size is 3×3, and S1 represents a convolution step of 1).

\textcircled{2}. Comparison between a network structure of a hyper decoder net (Hyper Decoder_UV) for processing a chrominance component and a network structure of a light weighted hyper decoder net (Light weighted Hyper Decoder_UV) for processing the chrominance component.

As shown by FIG. 27 in FIG. 2C, to process the chrominance component, the hyper decoder net mainly includes five convolutional layers, two crop layers (Crop), and three activation functions (LeakyRelu). The five convolutional layers from top to bottom are sequentially as follows: Conv64×3×3S1 (Conv represents convolution, a channel quantity is 64, a convolution kernel size is 3×3, and S1 represents a convolution step of 1), DConv64×3×3S2 (DConv represents deconvolution, a channel quantity is 64, a convolution kernel size is 3×3, and S2 represents a convolution step of 2), Conv64×3×3S1 (Conv represents convolution, a channel quantity is 64, a convolution kernel size is 3×3, and S1 represents a convolution step of 1), DConv96×3×3S2 (DConv represents deconvolution, a channel quantity is 96, a convolution kernel size is 3×3, and S2 represents a convolution step of 2), and Conv64×3×3S1 (Conv represents convolution, a channel quantity is 64, a convolution kernel size is 3×3, and S1 represents a convolution step of 1).

As shown by FIG. 28 in FIG. 2C, to process the chrominance component, the light weighted hyper decoder net mainly includes five convolutional layers, two crop layers (Crop), and three activation functions (LeakyRelu). The five convolutional layers from top to bottom are sequentially as follows: Conv64×1×1S1 (Conv represents convolution, a channel quantity is 64, a convolution kernel size is 1×1, and S1 represents a convolution step of 1), DConv64×4×4S2 (DConv represents deconvolution, a channel quantity is 64, a convolution kernel size is 4×4, and S2 represents a convolution step of 2), Conv64×3×3S1 (Conv represents convolution, a channel quantity is 64, a convolution kernel size is 3×3, and S1 represents a convolution step of 1), DConv64×4×4S2 (DConv represents deconvolution, a channel quantity is 64, a convolution kernel size is 4×4, and S2 represents a convolution step of 2), and Conv64×3×3S1 (Conv represents convolution, a channel quantity is 64, a convolution kernel size is 3×3, and S1 represents a convolution step of 1).

It may be learned from the comparison between 25 and 26 and the comparison between 27 and 28 in FIG. 2C that, the convolutional layers in the network structure of the hyper decoder net and the network structure of the light weighted hyper decoder net for processing the luminance component or the chrominance component have a particular difference.

(3). A network structure of the hyper scale decoder net is compared with a network structure of the light weighted hyper scale decoder net.

FIG. 2D is a schematic diagram of comparison between network structures of a hyper scale decoder net and a light weighted hyper scale decoder net for processing a chrominance component and a luminance component according to an exemplary embodiment of this application.

\textcircled{1}. Comparison between a network structure of a hyper scale decoder net (Hyper Scale Decoder_Y) for processing a luminance component and a network structure of a light weighted hyper scale decoder net (Light weighted Hyper Scale Decoder_Y) for processing the luminance component.

As shown by FIG. 29 in FIG. 2D, to process the luminance component, the hyper scale decoder net mainly includes six convolutional layers, two crop layers (Crop), and five activation functions (LeakyRelu). The six convolutional layers from top to bottom are sequentially as follows: DConv128×5×5S2 (DConv represents deconvolution, a channel quantity is 128, a convolution kernel size is 5×5, and S2 represents a convolution step of 2), DConv192×5×5S2 (DConv represents deconvolution, a channel quantity is 192, a convolution kernel size is 5×5, and S2 represents a convolution step of 2), Conv256×3×3S1 (Conv represents convolution, a channel quantity is 256, a convolution kernel size is 3×3, and S1 represents a convolution step of 1), Conv212×3×3S1 (Conv represents convolution, a channel quantity is 212, a convolution kernel size is 3×3, and S1 represents a convolution step of 1), Conv170×3×3S1 (Conv represents convolution, a channel quantity is 170, a convolution kernel size is 3×3, and S1 represents a convolution step of 1), and Conv128×3×3S1 (Conv represents convolution, a channel quantity is 128, a convolution kernel size is 3×3, and S1 represents a convolution step of 1).

As shown by FIG. 30 in FIG. 2D, to process the luminance component, the light weighted hyper scale decoder net mainly includes four convolutional layers, two crop layers (Crop), and three activation functions (LeakyRelu). The four convolutional layers from top to bottom are sequentially as follows: DConv128×4×4S2 (DConv represents deconvolution, a channel quantity is 128, a convolution kernel size is 4×4, and S2 represents a convolution step of 2), Conv128×3×3S1 (Conv represents convolution, a channel quantity is 128, a convolution kernel size is 3×3, and S1 represents a convolution step of 1), DConv128×4×4S2 (DConv represents deconvolution, a channel quantity is 128, a convolution kernel size is 4×4, and S2 represents a convolution step of 2), and Conv128×3×3S1 (Conv represents convolution, a channel quantity is 128, a convolution kernel size is 3×3, and S1 represents a convolution step of 1).

\textcircled{2}. Comparison between a network structure of a hyper scale decoder net (Hyper Scale Decoder_UV) for processing a chrominance component and a network structure of a light weighted hyper scale decoder net (Light weighted Hyper Scale Decoder UV) for processing the chrominance component.

As shown by FIG. 31 in FIG. 2D, to process the chrominance component, the hyper scale decoder net mainly includes six convolutional layers, two crop layers (Crop), and five activation functions (LeakyRelu). The six convolutional layers from top to bottom are sequentially as follows: DConv64×5×5S2 (DConv represents deconvolution, a channel quantity is 64, a convolution kernel size is 5×5, and S2 represents a convolution step of 2), DConv96×5×5S2 (DConv represents deconvolution, a channel quantity is 96, a convolution kernel size is 5×5, and S2 represents a convolution step of 2), Conv128×3×3S1 (Conv represents convolution, a channel quantity is 128, a convolution kernel size is 3×3, and S1 represents a convolution step of 1), Conv106×3×3S1 (Conv represents convolution, a channel quantity is 106, a convolution kernel size is 3×3, and S1 represents a convolution step of 1), Conv85×3×3S1 (Conv represents convolution, a channel quantity is 85, a convolution kernel size is 3×3, and S1 represents a convolution step of 1), and Conv64×3×3S1 (Conv represents convolution, a channel quantity is 64, a convolution kernel size is 3×3, and S1 represents a convolution step of 1).

As shown by FIG. 32 in FIG. 2D, to process the chrominance component, the light weighted hyper scale decoder net mainly includes four convolutional layers, two crop layers (Crop), and three activation functions (LeakyRelu). The four convolutional layers from top to bottom are sequentially as follows: DConv64×4×4S2 (DConv represents deconvolution, a channel quantity is 64, a convolution kernel size is 4×4, and S2 represents a convolution step of 2), Conv64×3×3S1 (Conv represents convolution, a channel quantity is 64, a convolution kernel size is 3×3, and S1 represents a convolution step of 1), DConv64×4×4S2 (DConv represents deconvolution, a channel quantity is 64, a convolution kernel size is 4×4, and S2 represents a convolution step of 2), and Conv64×3×3S1 (Conv represents convolution, a channel quantity is 64, a convolution kernel size is 3×3, and S1 represents a convolution step of 1).

It may be learned from the comparison between 29 and 30 and the comparison between 31 and 32 in FIG. 2D that, the network structures of the hyper scale decoder net for processing the luminance component and the chrominance component have higher complexity than those of the light weighted hyper scale decoder net, and the convolutional layers in the hyper scale decoder net and the light weighted hyper scale decoder net for processing the luminance component and the chrominance component have a particular difference (for example, have different channel quantities).

### 3. Conventional Convolution (or Referred to as Convolution) and Group Convolution

Conventional convolution means performing convolution processing on feature maps of all inputted images together in a convolutional layer. During a conventional convolution operation, each output channel is connected to (interacts with) each input channel, and the channels are in a dense connection. The output channel is an output feature map after convolution, and the input channel is an input feature map. Exemplarily, FIG. 2E is a schematic diagram of comparison between a conventional convolution operation and a group convolution operation according to an exemplary embodiment of this application. As shown in FIG. 2E (1), output channels (to be specific, an output channel a to an output channel h) on an upper layer are all connected to input channels (to be specific, an input channel 1 to an input channel 8) on a lower layer. For example, the output channel a is respectively connected to the input channel 1 to the input channel 8, the output channel b is respectively connected to the input channel 1 to the input channel 8, and so on. Therefore, the conventional convolution operation inevitably has relatively large calculation complexity. In addition, it may be learned from the end-to-end encoding/decoding model based on deep learning that, the entire model involves a relatively large quantity of convolutional layers. If the conventional convolution is performed in the convolutional layers, an entire image encoding/decoding process has relatively high calculation complexity, reducing encoding/decoding efficiency.

The group convolution refers to grouping, in a convolutional layer, feature maps of an inputted image based on a channel, to obtain a plurality of groups. Then a convolution operation is performed in each of the plurality of groups, to obtain a convolution result of each group, for example, a feature map of a channel included in each group. The convolution results of the plurality of groups may be spliced. Exemplarily, the input channels and the output channels may be divided into a plurality of groups. An output channel in each group is connected to only an input channel in the group, and is unrelated to a channel in others of the plurality of groups. As shown in FIG. 2E (2), the convolutional layer includes eight input channels (for example, an input channel 1 to an input channel 8) and eight output channels (an output channel a to an output channel h). The eight input channels and the eight output channels may be divided into four groups, and each group includes two input channels and two output channels. For example, a group 1 includes the input channel 1, the input channel 2, the output channel a, and the output channel b, a group 2 includes the input channel 3, the input channel 4, the output channel c, and the output channel d, a group 3 includes the input channel 5, the input channel 6, the output channel e, and the output channel f, and a group 4 includes the input channel 7, the input channel 8, the output channel g, and the output channel h. It may be learned that in the foregoing four groups, the two output channels in each group are connected to only the two input channels in the group.

It may be learned that the group convolution can reduce calculation complexity to some extent. Therefore, in the embodiments of this application, the group convolution may be introduced into the end-to-end encoding/decoding model based on deep learning, to reduce calculation complexity of an entire encoding/decoding process, thereby improving encoding/decoding efficiency.

### 4. Channel Reconstruction

The channel reconstruction may be configured for implementing feature communication between channels. After the group convolution processing is performed, feature map communication between the groups may be implemented through channel reconstruction, so that accuracy of feature extraction can be effectively ensured during subsequent processing. In the embodiments of this application, the channel reconstruction may refer to reordering feature maps corresponding to channels obtained after the group convolution, to implement information flow between different groups. For example, FIG. 2F is a schematic diagram of channel reconstruction according to an exemplary embodiment of this application. As shown in FIG. 2F (a), the channels are divided into three groups (in FIG. 2F (a), different colors are used for illustration). Each group is inputted to the first convolutional layer for group convolution processing, to obtain a group convolution feature corresponding to each group. Then the group convolution feature corresponding to each group is inputted to the second convolutional layer for group convolution processing. In FIG. 2F (a), channel reconstruction is not performed, and therefore communication between group convolution features of different groups cannot be achieved, which may reduce a feature extraction capability of the model.

To resolve the problem, it is considered to group convolution features outputted through a group convolution operation through channel reconstruction. As shown in FIG. 2F (b), the plurality of channels are divided into three groups (in FIG. 2F (b), different colors are used for illustration). Each group is inputted to the first convolutional layer for group convolution processing, to obtain a group convolution feature corresponding to each group. Then the group convolution features corresponding to all of the groups are reordered to obtain a channel reconstruction result. For example, a group convolution feature corresponding to the first group includes a convolution feature of the channel 1, a convolution feature of the channel 2, and a convolution feature of the channel 3, a group convolution feature corresponding to the second group includes a convolution feature of the channel 4, a convolution feature of the channel 5, and a convolution feature of the channel 6, and a group convolution feature corresponding to the third group includes a convolution feature of the channel 7, a convolution feature of the channel 8, and a convolution feature of the channel 9. The group convolution features corresponding to the three groups are reordered to obtain a channel reordering result. The channel reordering result is as follows: the convolution feature of the channel 1, the convolution feature of the channel 4, the convolution feature of the channel 7, the convolution feature of the channel 2, the convolution feature of the channel 5, the convolution feature of the channel 8, the convolution feature of the channel 3, the convolution feature of the channel 6, and the convolution feature of the channel 9. Then the channel reordering result is inputted to a next convolutional layer (the second convolutional layer) for processing.

It may be learned that after the channel reconstruction processing, feature communication between the groups is implemented, which can ensure that inputs for next group convolution are from different groups, and can improve a feature extraction capability of the model. In addition, the channel reconstruction is merely to reorder the feature maps corresponding to the channels, which reduces additional calculation operations.

An embodiment of this application provides an image processing solution. The image processing solution may be applied to the end-to-end image encoding model based on deep learning. The image processing solution can simplify the end-to-end image encoding model based on deep learning. The image processing solution is as follows: Decoding indication information is provided on a decoder side, the decoding indication information being configured for indicating a decoding simplification operation to be performed in a decoding neural network. Then the decoding neural network is invoked based on the decoding indication information to perform decoding processing on a bit stream, to reconstruct an image. During the decoding of the image, the indication of the decoding indication information can simplify a decoding operation in the decoding neural network on a decoder side, which can effectively reduce decoding complexity on the decoder side, thereby improving decoding efficiency. In addition, the solution can be well supported by a mobile device (that is, a decoding device).

An image processing system provided in an embodiment of this application is described below.

FIG. 3 is a schematic structural diagram of an image processing system according to an exemplary embodiment of this application. The image processing system may include an encoding device 301 and a decoding device 302. The encoding device 301 is located on an encoder side, and the decoding device 302 is located on a decoder side. The encoding device 301 may be a terminal, or may be a server. The decoding device 302 may be a terminal, or may be a server. A communicative connection may be established between the encoding device 301 and the decoding device 302. The terminal may be a smartphone, a tablet computer, a notebook computer, a desktop computer, a smart speaker, a smartwatch, an on-board terminal, or a smart television, but is not limited thereto. The server may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

### (1). Encoding Device 301

The encoding device 301 may obtain a to-be-processed image. The image may be captured by a camera device or generated by a computer. The camera device may be a hardware component arranged in the encoding device 301. For example, the camera device may be an ordinary camera, a stereo camera, an optical field camera, or the like arranged in a terminal. The camera device may alternatively be a hardware apparatus connected to the encoding device 301, for example, a camera connected to a server.

Then the encoding device 301 may invoke an encoding neural network to perform encoding processing on the obtained image, to obtain a bit stream corresponding to the image. The encoding neural network may include the analysis transform net shown in FIG. 1A and the like, or the encoding neural network may include the light weighted analysis transform net shown in FIG. 1B.

In an implementation, an example in which the encoding neural network may include the analysis transform net shown in FIG. 1A is used. The image includes a chrominance component and a luminance component. The encoding device 301 may respectively perform nonlinear transform processing on the chrominance component x_{Y} and the luminance component x_{UV} through the analysis transform net shown in FIG. 1A, to obtain a transformation result y_{Y} of the luminance component and a transformation result y_{UV} of the chrominance component. Then the encoding device 301 performs a difference operation on the transformation result y_{Y} of the luminance component and a predicted value of the luminance component outputted by the prediction fusion net, to obtain a residual r_{Y} of the luminance component, and performs a difference operation on the transformation result y_{UV} of the chrominance component and a predicted value of the chrominance component outputted by the prediction fusion net, to obtain a residual r_{UV} of the chrominance component. Next, the encoding device 301 performs quantization processing on the residual r_{Y} of the luminance component and the residual r_{UV} of the chrominance component, to convert them into an integer residual \hat{r}_{Y} of the luminance component and an integer residual \hat{r}_{UV} of the chrominance component to form a bit stream.

In another implementation, during the encoding of the image, encoding indication information may be pre-configured. The encoding indication information is configured for indicating an encoding simplification operation to be performed in the encoding neural network. Then the encoding device 301 invokes, based on the encoding indication information, the encoding neural network to perform encoding processing on the image, to obtain the bit stream. Exemplarily, an example in which the encoding neural network may include the analysis transform net shown in FIG. 1A is used. The encoding indication information may be configured for indicating an encoding simplification operation to be performed in the analysis transform net. In this case, the encoding device 301 invokes, based on the encoding indication information, the analysis transform net to perform an encoding simplification operation on the image, to obtain the bit stream.

Performing the encoding simplification operation in the encoding neural network can reduce complexity on the encoder side to some extent, thereby improving encoding efficiency. A specific implementation of invoking, based on the encoding indication information, the encoding neural network to perform encoding processing on the image, to obtain the bit stream is described in subsequent embodiments, which is not described in detail herein.

After obtaining the bit stream, the encoding device 301 may transmit the bit stream to the decoding device 302, so that the decoding device 302 performs decoding processing on the bit stream to reconstruct the image.

### (2). Decoding Device 302

The decoding device 302 receives the bit stream transmitted by the encoding device 301, and obtains decoding indication information. The decoding indication information is configured for indicating a decoding simplification operation to be performed in a decoding neural network. The decoding device 302 invokes, based on the decoding indication information, a decoding neural network to perform decoding processing on the bit stream, to reconstruct the image. Specifically, when the image includes a luminance component and a chrominance component, the decoding device 302 may perform decoding processing on the bit stream to obtain a residual \hat{r}, including a residual \hat{r}_{Y} of the luminance component and a residual \hat{r}_{UV} of the chrominance component. Then the decoding device 302 performs superposition on the residual \hat{r}Y of the luminance component and a predicted value u_{Y} of the luminance component outputted by the prediction fusion net, to obtain a transformation value ŷ_{Y} of the luminance component, and performs superposition on the residual \hat{r}_{UV} of the chrominance component and a predicted value u_{UV} of the chrominance component outputted by the prediction fusion net, to obtain a transformation value ŷ_{UV} of the chrominance component. Then the decoding neural network is invoked to perform the decoding simplification operation on the transformation value ŷ_{Y} of the luminance component and the transformation value ŷ_{UV} of the chrominance component, to reconstruct the image.

In an implementation, the decoding simplification operation may include a group convolution operation, and the decoding indication information is configured for indicating that the group convolution operation needs to be performed in the decoding neural network. In this implementation, that the decoding neural network is invoked to perform the decoding simplification operation on the transformation value of the luminance component and the transformation value of the chrominance component, to reconstruct the image may be as follows: The decoding device 302 invokes, based on the decoding indication information, the decoding neural network to respectively perform the group convolution operation on the transformation value of the luminance component and the transformation value of the chrominance component, to reconstruct the image. The transformation value of the luminance component and the transformation value of the chrominance component are, for example, included in a feature map of the image.

In another implementation, the decoding simplification operation may include a group convolution operation and a channel reconstruction operation, and the decoding indication information is configured for indicating that the group convolution operation and the channel reconstruction operation need to be performed in the decoding neural network. In this implementation, that the decoding neural network is invoked to perform the decoding simplification operation on the transformation value of the luminance component and the transformation value of the chrominance component, to reconstruct the image may be as follows: The decoding device 302 invokes, based on the decoding indication information, the decoding neural network to perform the group convolution operation on the transformation value of the luminance component, to obtain a group convolution result of the luminance component; invokes the decoding neural network to perform the group convolution operation on the transformation value of the chrominance component, to obtain a group convolution result of the chrominance component; and respectively performs the channel reconstruction operation on the group convolution result of the luminance component and performs the channel reconstruction operation on the group convolution result of the chrominance component, to obtain a channel reconstruction result of the luminance component and a channel reconstruction result of the chrominance component. The channel reconstruction result of the luminance component and the channel reconstruction result of the chrominance component are configured for reconstructing the image.

The decoding neural network may include the synthesis transform net, the hyper decoder net, the hyper scale decoder net, and the like shown in FIG. 1A. Alternatively, the decoding neural network may include the light weighted synthesis transform net, the light weighted hyper decoder net, the light weighted hyper scale decoder net, and the like shown in FIG. 1B. This is not limited in this application.

In an embodiment of this application, the encoding indication information may be configured on the encoding device 301 side, and the decoding indication information is not configured on the decoding device 302 side. Calculation complexity on the encoder side is reduced through the encoding indication information, thereby improving encoding efficiency. Alternatively, the decoding indication information may be configured on the decoding device 302 side, and the decoding indication information is not configured on the encoding device 301 side. Decoding complexity on the decoder side is reduced through the encoding indication information, thereby improving decoding efficiency. Certainly, the encoding indication information may be configured on the encoding device 301 side and the decoding indication information may be configured on the decoding device 302 side, to reduce complexity of an image encoding/decoding process, thereby improving encoding/decoding efficiency.

An image processing method provided in an embodiment of this application is described below.

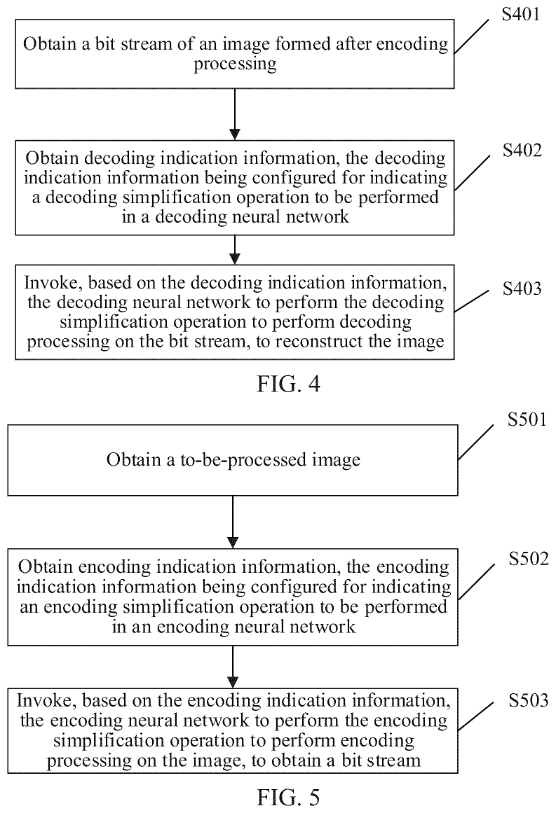

FIG. 4 is a schematic flowchart of an image processing method according to an exemplary embodiment of this application. The image processing method may be performed by the decoding device 302. The image processing method may include the following operations S401 to S403.

Operation S401: Obtain a bit stream of an image formed after encoding processing.

Operation S402: Obtain decoding indication information, the decoding indication information being configured for indicating a decoding simplification operation to be performed in a decoding neural network. The decoding simplification operation is configured for performing grouping processing on a convolution operation performed in at least one convolutional layer included in the decoding neural network. The grouping processing performed on the convolution operation performed in the convolutional layer is referred to as a group convolution operation.

The decoding neural network may be at least one of a hyper decoder net, a hyper scale decoder net, and a synthesis transform net. The hyper decoder net may be the hyper decoder net shown in FIG. 1A, or may be the light weighted hyper decoder net shown in FIG. 1B. The hyper scale decoder net may be the hyper scale decoder net shown in FIG. 1A, or may be the light weighted hyper scale decoder net shown in FIG. 1B. The synthesis transform net may be the synthesis transform net shown in FIG. 1A, or may be the light weighted synthesis transform net shown in FIG. 1B. The decoding simplification operation includes a group convolution operation. Alternatively, the decoding simplification operation includes a group convolution operation and a channel reconstruction operation.

(1). The decoding simplification operation includes a group convolution operation.

The decoding indication information includes decoding group convolution indication information. The decoding neural network includes at least one convolutional layer. A quantity of the at least one convolutional layer may be N, N being a positive integer. The decoding group convolution indication information is configured for instructing to perform a group convolution operation in the at least one convolutional layer of the decoding neural network. The group convolution operation includes: performing, in the at least one convolutional layer, grouping on feature maps of the image based on a channel, to obtain a plurality of groups; and performing a convolution operation in each of the plurality of groups, to obtain a group convolution feature of each group, the group convolution feature of each group including a convolution feature of a channel in the group. An output channel in each of the plurality of groups interacts with only an input channel in the group, and is unrelated to a channel in others of the plurality of groups. Instructing to perform the group convolution operation in the convolutional layer of the decoding neural network can achieve grouping processing on convolution operations involved in the convolutional layer of the decoding neural network, to avoid relatively large calculation complexity caused by simultaneously performing convolution operations on all input features, which reduces calculation complexity, and reduces decoding complexity, thereby improving decoding efficiency.

The decoding group convolution indication information may be configured in a network structure of the convolutional layer of the decoding neural network. Exemplarily, the decoding neural network is the synthesis transform net in FIG. 1A, and the decoding indication information is configured for instructing to perform the group convolution operation in a convolutional layer (DConv128×3×3S2). In this case, the decoding group convolution indication information may be configured in a network structure of the convolutional layer. Exemplarily, the convolutional layer may be represented as DConv128×3×3S2G2, G2 representing that a quantity of groups on which the group convolution operation is to be performed is 2.

Further, the decoding group convolution indication information is further configured for indicating a quantity of groups in the convolutional layer of the decoding neural network on which the group convolution operation is to be performed. The quantity of groups may be set based on experience. For example, the quantity of groups may be set to 2, 4, 8, or the like. For example, based on experience, when the quantity of groups is 4, decoding complexity during decoding can be reduced and decoding performance can be ensured. Therefore, the decoding group convolution indication information is configured for indicating that the quantity of groups on which the group convolution operation is to be performed is 4.

The quantity of groups during the group convolution operation indicated by the decoding group convolution indication information is configured to be dynamically changed as a network parameter of the convolutional layer of the decoding neural network changes. The network parameter includes at least one of the following: a quantity of channels, feature data of a feature map inputted into a convolutional layer, and a bit rate point during image encoding/decoding.

\textcircled{1}. The network parameter includes a quantity of channels. When a quantity of channels in a convolutional layer of the decoding neural network on which the group convolution operation is to be performed changes, a quantity of groups during the group convolution operation is to be performed needs to be dynamically adjusted. For example, when a quantity of channels in a convolutional layer on which the group convolution operation is to be performed changes from 128 to 64, a quantity of groups during the group convolution operation may be adjusted from 8 to 4. \textcircled{2}. The network parameter includes feature data of a feature map inputted into a convolutional layer. For example, when the feature data of the feature map inputted into the convolutional layer of the decoding neural network includes a chrominance component and a luminance component of an image, a quantity of groups during the group convolution operation on the chrominance component in the convolutional layer of the decoding neural network is different from a quantity of groups during the group convolution operation on the luminance component in the convolutional layer. \textcircled{3}. The network parameter includes a bit rate point during encoding/decoding. When a new bit rate point is used for encoding/decoding processing of a different image, a quantity of groups during the group convolution operation needs to be dynamically adjusted. Images of different sources correspond to different bit rate points during encoding/decoding processing. For example, an image which is an animation image generated by a computer and an image which is a picture of screen content correspond to different bit rate points during encoding/decoding processing.

In an embodiment, the decoding group convolution indication information is further configured for indicating n convolutional layers of the N convolutional layers in which the group convolution operation is to be performed, n being a positive integer and n being less than or equal to N. Exemplarily, the decoding neural network includes the synthesis transform net shown in FIG. 1A. For example, the synthesis transform net in FIG. 1A includes four (in other words, N=4) convolutional layers. In this case, the decoding group convolution indication information may be configured for indicating two (n=2) convolutional layers (to be specific, DConv128×3×3S2 and DConv128×3×3S2) in the N convolutional layers in which the group convolution operation needs to be performed. In other words, the group convolution operation needs to be performed in the convolutional layer DConv128×3×3S2 and the convolutional layer DConv128×3×3S2.

Further, the decoding group convolution indication information is further configured for indicating a quantity of groups in each of the n convolutional layers on which the group convolution operation is to be performed. The quantities of groups in different convolutional layers of the n convolutional layers on which the group convolution operation is to be performed may all be the same, or the quantities of groups in different convolutional layers of the n convolutional layers on which the group convolution operation is to be performed are partially the same, or the quantities of groups in different convolutional layers of the n convolutional layers on which the group convolution operation is to be performed are completely different. Exemplarily, a quantity of groups in a convolutional layer on which the group convolution operation is to be performed may be 4, and a quantity of groups in another convolutional layer on which the group convolution operation is to be performed may be 2.

A selection rule for the n convolutional layers may include at least one of the following: \textcircled{1}. The n convolutional layers in which the group convolution operation is to be performed is selected from the N convolutional layers in descending order of distances between the convolutional layers and the output layer. For example, when the decoding neural network is the light weighted synthesis transform net shown in FIG. 1B, and a distance between the convolutional layer Conv64×3×3S1 and the output layer is greater than a distance between the convolutional layer Conv16×1×1S1 and the output layer, the convolutional layer Conv64×3×3S1 may be selected as a convolutional layer in which the group convolution operation needs to be performed. \textcircled{2}. The n convolutional layers in which the group convolution operation is to be performed is selected from the N convolutional layers in descending order of complexity of network structures. Exemplarily, the decoding neural network includes a convolutional layer 1, a convolutional layer 2, and a convolutional layer 3, and complexity of a network structure of the convolutional layer 1 is greater than complexity of a network structure of the convolutional layer 2, and the complexity of the network structure of the convolutional layer 2 is greater than complexity of a network structure of the convolutional layer 3. In this case, the convolutional layer 1 and the convolutional layer 2 may be selected as convolutional layers in which the group convolution operation is to be performed.

During selection of a convolutional layer in which the group convolution operation is to be performed, a convolutional layer with relatively high complexity may be selected to perform the group convolution operation, to reduce calculation complexity of the convolutional layer, thereby reducing decoding complexity. In addition, during selection of a convolutional layer in which the group convolution operation is to be performed, the convolutional layer in which the group convolution operation is to be performed may be determined in consideration of complexity and decoding performance of the decoding neural network, to reduce complexity and ensure decoding performance.

(2). The decoding simplification operation includes a channel reconstruction operation and a group convolution operation. Information exchange between groups may be implemented through the channel reconstruction operation, and the channel reconstruction does not generate an additional calculation operation. Therefore, not only an image feature extraction capability of the decoding neural network is effectively ensured, but also decoding performance is effectively ensured and decoding complexity is reduced.

The decoding indication information includes decoding group convolution indication information and decoding channel reconstruction indication information. The decoding group convolution indication information is configured for instructing to perform the group convolution operation in a convolutional layer of the decoding neural network. For the decoding group convolution indication information, refer to the foregoing content of (1), and details are not described herein. The decoding channel reconstruction indication information is configured for instructing to perform the channel reconstruction operation in a convolutional layer of the decoding neural network. The decoding channel reconstruction indication information may be configured in a network structure of the convolutional layer of the decoding neural network.

A convolutional layer in which the channel reconstruction operation is performed is a convolutional layer in which a group convolution operation is performed. When the quantity of the at least one convolutional layer of the decoding neural network is N and the N convolutional layers include n convolutional layers in which the group convolution operation is to be performed, N and n both being positive integers and n being less than or equal to N, the decoding channel reconstruction indication information is further configured for indicating t convolutional layers of the n convolutional layers in which the channel reconstruction operation is to be performed, t being a positive integer and t being less than or equal to n.

In an embodiment, the decoding channel reconstruction indication information is further configured for indicating a quantity of channels during the channel reconstruction operation. When a quantity of convolutional layers in which the channel reconstruction operation is to be performed is t, the decoding channel reconstruction indication information is further configured for indicating a quantity of channels in each of the t convolutional layers on which the channel reconstruction operation is to be performed. The quantities of channels in all of the t convolutional layers on which the channel reconstruction operation is to be performed may all be the same. Alternatively, the quantities of channels in all of the t convolutional layers on which the channel reconstruction operation is to be performed may be partially the same. For example, a quantity of channels in the convolutional layer 1 on which the channel reconstruction operation is to be performed is 4, a quantity of channels in the convolutional layer 2 on which the channel reconstruction operation is to be performed is 4, and a quantity of channels in the convolutional layer 3 on which the channel reconstruction operation is to be performed is 6. Alternatively, the quantities of channels in all of the t convolutional layers on which the channel reconstruction operation is to be performed may be completely different.

The quantity of channels during the channel reconstruction operation indicated by the decoding channel reconstruction indication information is configured to be dynamically adjusted as the network parameter of the convolutional layer of the decoding neural network changes. The network parameter includes at least one of the following: a quantity of channels, feature data of an inputted feature map, and a bit rate point during encoding/decoding.

\textcircled{1}. The network parameter includes a quantity of channels. When a quantity of channels in a convolutional layer on which the group convolution operation is to be performed changes, a quantity of channels on which the channel reconstruction operation is to be performed needs to be dynamically adjusted. For example, when a quantity of channels in a convolutional layer on which the group convolution operation is to be performed changes from 128 to 64, a quantity of channels during the channel reconstruction operation may be adjusted from 128 to 64. \textcircled{2}. The network parameter includes feature data of a feature map inputted into a convolutional layer. For example, when the feature data of the feature map inputted into the convolutional layer of the decoding neural network includes a chrominance component and a luminance component of an image, a quantity of channels during the channel reconstruction operation on the chrominance component in the convolutional layer of the decoding neural network is different from a quantity of channels during the channel reconstruction operation on the luminance component in the convolutional layer. \textcircled{3}. The network parameter includes a bit rate point during encoding/decoding. When a different bit rate point is used for encoding/decoding processing of a different image, a quantity of channels during the channel reconstruction operation needs to be dynamically adjusted.

When the convolutional layer includes P channels, the decoding channel reconstruction indication information is further configured for indicating p channels of the P channels on which the channel reconstruction operation is to be performed. In other words, the decoding channel reconstruction indication information is configured for indicating the quantity of channels during the channel reconstruction operation and indicating channels of the P channels on which the channel reconstruction operation is to be performed. In an implementation, when each channel corresponds to a channel identifier, for example, a channel index, an index value of a channel on which the channel reconstruction operation is to be performed may be indicated in the decoding channel reconstruction indication information. The quantity of channels and the channel index are both parameters of a channel pixel. Exemplarily, the convolutional layer includes 64 channels, and index values successively corresponding to the 64 channels are 0 to 63. The decoding channel reconstruction indication information is configured for indicating that the quantity of channels during the channel reconstruction operation is 32 and indicating that the 32 (p=32) channels on which the channel reconstruction operation is to be performed are 0-3, 10-13, 20-23, and 30-33.

A selection rule for the p channels may include at least one of the following: \textcircled{1}. The p channels on which the channel reconstruction operation is to be performed are selected from the P channels based on a rule of reducing a memory resource consumption amount. Exemplarily, P=64, and the 64 channels are stored at different memory locations. During the channel reconstruction operation, memory resource consumption for obtaining the 64 channels from the memory locations of the 64 channels is different. Therefore, 32 channels on which the channel reconstruction operation is to be performed may be selected from the 64 channels in ascending order of memory resource consumption. \textcircled{2}. The P channels respectively correspond to a plurality of groups on which the group convolution operation is to be performed. For example, the quantity of groups is 4, and P=64. The 64 channels respectively correspond to the four groups on which the group convolution operation is to be performed, and each group includes 16 channels. In this way, based on a data communication demand between the groups, p channels on which the channel reconstruction operation is to be performed may be selected from the P channels. For example, if a data communication demand is to enable features between the groups to be from other groups, all of the 64 channels may be selected as channels on which the channel reconstruction operation is to be performed.

In an embodiment, the decoding neural network includes at least one of the following: a hyper decoder net, a hyper scale decoder net, and a synthesis transform net. Each net includes a convolutional layer. The decoding simplification operation includes a group convolution operation. If the decoding indication information indicates that the group convolution operation is to be performed in the convolutional layers of all nets, quantities of groups in the convolutional layers of all of the nets on which the group convolution operation is to be performed indicated by the decoding indication information may all be the same, or the quantities of groups in the convolutional layers of the nets on which the group convolution operation is to be performed indicated by the decoding indication information may be partially the same, or the quantities of groups in the convolutional layers of the nets on which the group convolution operation is to be performed indicated by the decoding indication information may be completely different.

Further, the decoding simplification operation includes a group convolution operation and a channel reconstruction operation. If the decoding indication information instructing to perform the channel reconstruction operation in the convolutional layers of all of the nets, quantities of channels in the convolutional layers of all of the nets on which the channel reconstruction operation is to be performed indicated by the decoding indication information may all be the same. Alternatively, the quantities of channels in the convolutional layers of all of the nets on which the channel reconstruction operation is to be performed indicated by the decoding indication information may be partially the same and partially different. Alternatively, the quantities of channels in the convolutional layers of all of the nets on which the channel reconstruction operation is to be performed indicated by the decoding indication information may be completely different (for example, the decoding indication information is configured for indicating that a quantity of channels in the convolutional layer of the hyper decoder net on which the channel reconstruction operation is to be performed is 4, and a quantity of channels in the synthesis transform net on which the channel reconstruction operation is to be performed is 32). This is not limited in this application.

Operation S403: Invoke, based on the decoding indication information, the decoding neural network to perform the decoding simplification operation to perform decoding processing on the bit stream, to reconstruct the image.

When the decoding neural network includes at least one convolutional layer, the decoding simplification operation includes a group convolution operation, and the decoding indication information is configured for instructing to perform the group convolution operation in the convolutional layer of the decoding neural network, the invoking, based on the decoding indication information, the decoding neural network to perform the decoding simplification operation to perform decoding processing on the bit stream, to reconstruct the image may include: invoking, based on the decoding indication information, the decoding neural network to perform decoding processing on the bit stream, to obtain a transformation value of the image; then invoking the at least one convolutional layer of the decoding neural network to perform the group convolution operation on the transformation value of the image, to obtain a group convolution result corresponding to the transformation value of the image; and performing decoding processing on the group convolution result, to reconstruct the image. Specifically, the decoding indication information includes decoding group convolution indication information, and the decoding group convolution indication information is configured for indicating a quantity of groups during the group convolution operation. The decoding device may perform grouping processing on the transformation value of the image based on the quantity of groups, to obtain one or more groups, and then perform the convolution operation on each group, to obtain the group convolution result corresponding to the transformation value of the image.

When the decoding simplification operation includes a group convolution operation and a channel reconstruction operation, and the decoding indication information is configured for instructing to perform the group convolution operation and the channel reconstruction operation in the convolutional layer of the decoding neural network, the invoking, based on the decoding indication information, the decoding neural network to perform decoding processing on the bit stream, to obtain a transformation value of the image may include: invoking, based on the decoding indication information, the decoding neural network to perform decoding processing on the bit stream, to obtain a transformation value of the image; then invoking the at least one convolutional layer of the decoding neural network to perform the group convolution operation on the transformation value of the image, to obtain a group convolution result corresponding to the transformation value of the image; and then performing the channel reconstruction operation on the group convolution result, to obtain a channel reconstruction result, and decoding the channel reconstruction result, to reconstruct the image.

The group convolution result includes a convolution feature of each of a plurality of channels, the decoding indication information includes decoding channel reconstruction indication information, and the decoding channel reconstruction indication information is further configured for indicating a quantity of channels during the channel reconstruction operation. The performing the channel reconstruction operation on the group convolution result, to obtain a channel reconstruction result may be: reordering the group convolution results based the quantity of channels indicated by the decoding channel reconstruction indication information, to obtain the channel reconstruction result.

In this embodiment of this application, the decoding indication information is provided on a decoder side, and the decoding indication information is configured for indicating the decoding simplification operation to be performed in the decoding neural network. Then the decoding neural network is invoked based on the decoding indication information to perform decoding processing on the bit stream, to reconstruct the image. During the decoding of the image, the indication of the decoding indication information can simplify a decoding operation in the decoding neural network on a decoder side, which can effectively reduce decoding complexity on the decoder side, thereby improving decoding efficiency. In addition, the solution can be well supported by a mobile device.

FIG. 5 is a schematic flowchart of an image processing method according to another exemplary embodiment of this application. The image processing method may be performed by the encoding device 301. The image processing method may include the following operations S501 to S503.

Operation S501: Obtain a to-be-processed image.

Operation S502: Obtain encoding indication information, the encoding indication information being configured for indicating an encoding simplification operation to be performed in an encoding neural network. The encoding simplification operation is configured for performing grouping processing on a convolution operation performed in at least one convolutional layer included in the encoding neural network. The grouping processing performed on the convolution operation performed in the convolutional layer is referred to as a group convolution operation.

The encoding neural network may include at least one of the following: an analysis transform net and a hyper encoder net. The encoding simplification operation may include a group convolution operation, or the encoding simplification operation may include a group convolution operation and a channel reconstruction operation.

(1). The encoding simplification operation includes a group convolution operation.

The encoding indication information includes encoding group convolution indication information. The encoding neural network includes at least one convolutional layer. The encoding group convolution indication information is configured for instructing to perform the group convolution operation in the convolutional layer of the encoding neural network. The encoding group convolution indication information is configured in a network structure of the convolutional layer of the encoding neural network. The group convolution operation includes: performing, in the at least one convolutional layer, grouping on feature maps of the image based on a channel, to obtain a plurality of groups; and performing a convolution operation in each of the plurality of groups, to obtain a group convolution feature of each group, the group convolution feature of each group including a convolution feature of a channel in the group. An output channel in each of the plurality of groups interacts with only an input channel in the group, and is unrelated to a channel in others of the plurality of groups.

Further, the encoding group convolution indication information is further configured for indicating a quantity of groups in the convolutional layer of the encoding neural network on which the group convolution operation is to be performed. The quantity of groups may be dynamically adjusted as a network parameter of the convolutional layer of the encoding neural network changes. The network parameter herein may include at least one of the following: a quantity of channels, feature data of a feature map inputted into a convolutional layer, and a bit rate point during encoding/decoding.

\textcircled{1}. The network parameter includes a quantity of channels. When a quantity of channels in a convolutional layer of the encoding neural network changes, a quantity of groups during the group convolution operation needs to be dynamically adjusted. For example, when a quantity of channels in a convolutional layer of the encoding neural network changes from 128 to 64, a quantity of groups during the group convolution operation may be adjusted from 8 to 4. \textcircled{2}. The network parameter includes feature data of a feature map inputted into a convolutional layer of the encoding neural network. For example, when the feature data of the feature map inputted into the convolutional layer of the encoding neural network includes a chrominance component and a luminance component of an image, a quantity of groups during the group convolution on the chrominance component in the convolutional layer is different from a quantity of groups during the group convolution on the luminance component in the convolutional layer. \textcircled{3}. The network parameter includes a bit rate point during encoding/decoding. When a new bit rate point is used for encoding/decoding processing of a different image, a quantity of groups during the group convolution operation needs to be dynamically adjusted. Images of different sources correspond to different bit rate points during encoding/decoding processing. When a different bit rate point is used for encoding/decoding of a different image, a quantity of groups during the group convolution operation needs to be dynamically adjusted.

A quantity of the at least one convolutional layer of the encoding neural network is M, M being a positive integer. The encoding group convolution indication information is further configured for indicating m convolutional layers of the M convolutional layers in which the group convolution operation is to be performed, m being a positive integer and m being less than or equal to M. A selection rule for the m convolutional layers includes at least one of the following: \textcircled{1}. The m convolutional layers in which the group convolution operation is to be performed is selected in descending order of distances to an output layer. \textcircled{2}. The m convolutional layers in which the group convolution operation is to be performed is selected in descending order of complexity of network structures. The selection rule for the m convolutional layers is similar to the selection rule for the n convolutional layers, except that the selection rule for the m convolutional layers is from an encoding perspective. Details are not described herein.

Further, the encoding group convolution indication information is further configured for indicating a quantity of groups in each of the m convolutional layers on which the group convolution operation is to be performed. The quantities of groups in different convolutional layers of the m convolutional layers on which the group convolution operation is to be performed may all be the same. Alternatively, or the quantities of groups in different convolutional layers of the m convolutional layers on which the group convolution operation is to be performed may be partially different and partially the same. Alternatively, the quantities of groups in different convolutional layers of the m convolutional layers on which the group convolution operation is to be performed may be completely different.

(2). The encoding simplification operation includes a group convolution operation and a channel reconstruction operation.

The encoding indication information may include encoding group convolution indication information and encoding channel reconstruction indication information. For the encoding group convolution indication information, refer to the related description of the foregoing content of (1), and details are not described herein. The encoding channel reconstruction indication information is configured for instructing to perform the channel reconstruction operation in a convolutional layer of the encoding neural network. The encoding channel reconstruction indication information is configured in a network structure of the convolutional layer of the encoding neural network. The channel reconstruction operation includes: reordering group convolution features of all groups obtained through the group convolution operation, to obtain reordered group convolution features.

Further, the encoding channel reconstruction indication information is further configured for indicating a quantity of channels in the convolutional layer of the encoding neural network on which the channel reconstruction operation is to be performed. The quantity of channels may be dynamically adjusted as a network parameter of the convolutional layer of the encoding neural network changes.

The convolutional layer includes I channels, and the encoding channel reconstruction indication information is further configured for indicating O channels of the I channels on which the channel reconstruction operation is to be performed, O being a positive integer and O being less than or equal to I. In other words, the encoding channel reconstruction indication information is configured for indicating the quantity of channels during the channel reconstruction operation and indicating channels of the I channels on which the channel reconstruction operation is to be performed. In an implementation, when each channel corresponds to a channel index, an index value of a channel on which the channel reconstruction operation is to be performed may be indicated in the encoding channel reconstruction indication information.

A selection rule for the O channels includes at least one of the following: selecting, based on a rule of reducing a memory resource consumption amount, the O channels on which the channel reconstruction operation is to be performed from the I channels; or selecting, based on a data communication demand among a plurality of groups during the group convolution operation corresponding to the O channels, the O channels on which the channel reconstruction operation is to be performed from the I channels. The selection rule for the O channels is similar to the selection rule for the foregoing p channels, except that the selection rule for the O channels is from an encoding perspective. Details are not described herein.

When the quantity of the at least one convolutional layer of the encoding neural network is M and the M convolutional layers include m convolutional layers in which the group convolution operation is to be performed, M and m both being positive integers and m being less than or equal to M, the encoding channel reconstruction indication information is further configured for indicating q convolutional layers of the m convolutional layers in which the channel reconstruction operation is to be performed, q being a positive integer and q being less than or equal to m.

Further, the encoding channel reconstruction indication information is further configured for indicating a quantity of channels in each of the q convolutional layers on which the channel reconstruction operation is to be performed. The quantities of channels in different convolutional layers of the q convolutional layers on which the channel reconstruction operation is to be performed may all be the same, or the quantities of channels in different convolutional layers of the q convolutional layers on which the channel reconstruction operation is to be performed may be partially the same and partially different, or the quantities of channels in different convolutional layers of the t convolutional layers on which the channel reconstruction operation is to be performed may be completely different.

The encoding neural network includes at least one of the following: an analysis transform net and a hyper encoder net. When the encoding simplification operation includes the group convolution operation, if the encoding indication information indicates that the group convolution operation is to be performed in convolutional layers of all nets, quantities of groups in the convolutional layers of all of the nets on which the group convolution operation is to be performed indicated by the encoding indication information may all be the same. Alternatively, the quantities of groups in the convolutional layers of all of the nets on which the group convolution operation is to be performed indicated by the encoding indication information may be partially the same and partially different. Alternatively, the quantities of groups in the convolutional layers of all of the nets on which the group convolution operation is to be performed indicated by the encoding indication information may be completely different (for example, the encoding indication information is configured for indicating that a quantity of groups in the convolutional layer of the hyper encoder net on which the group convolution operation is to be performed is 4, and a quantity of groups in the convolutional layer of the analysis transform net on which the group convolution operation is to be performed is 8).

When the encoding simplification operation include both a group convolution operation and a channel reconstruction operation, if the encoding indication information instructs to perform the channel reconstruction operation in the convolutional layers of all of the nets, the quantities of channels in the convolutional layers of all of the nets on which the channel reconstruction operation is to be performed indicated by the encoding indication information are all the same. Alternatively, the quantities of channels in the convolutional layers of the nets on which the channel reconstruction operation is to be performed indicated by the encoding indication information are partially the same and partially different. Alternatively, the quantities of channels in the convolutional layers of the nets on which the channel reconstruction operation is to be performed indicated by the encoding indication information are completely different (for example, the encoding indication information is configured for indicating that a quantity of channels in the convolutional layer of the hyper encoder net on which the channel reconstruction operation is to be performed is 16, and a quantity of channels in the convolutional layer of the analysis transform net on which the channel reconstruction operation is to be performed is 32).

S503: Invoke, based on the encoding indication information, the encoding neural network to perform the encoding simplification operation to perform encoding processing on the image, to obtain a bit stream.

When the encoding neural network includes a convolutional layer, the encoding simplification operation includes a group convolution operation, and the encoding indication information is configured for instructing to perform the group convolution operation in the convolutional layer of the encoding neural network, the invoking, based on the encoding indication information, the encoding neural network to perform encoding processing on the image, to obtain a bit stream may include: invoking the encoding neural network to perform the group convolution operation on the image, to obtain a group convolution result, and then performing encoding possessing (such as quantization) on the group convolution result, to obtain the bit stream of the image.

When the encoding neural network includes a convolutional layer, the encoding simplification operation includes a group convolution operation and a channel reconstruction operation, and the encoding indication information is configured for instructing to perform the group convolution operation and the channel reconstruction operation in the convolutional layer of the encoding neural network, the invoking, based on the encoding indication information, the encoding neural network to perform encoding processing on the image, to obtain a bit stream may include: invoking the encoding neural network to perform the group convolution operation on the image, to obtain a group convolution result, performing the channel reconstruction operation on the group convolution result, to obtain a channel reconstruction result of the image, and performing encoding possessing (such as quantization) on the channel reconstruction result, to obtain the bit stream of the image.

In an embodiment, the encoding neural network includes at least one convolutional layer, the encoding simplification operation includes a group convolution operation, and the encoding indication information includes encoding group convolution indication information, the encoding group convolution indication information being configured for instructing to perform the group convolution operation in the at least one convolutional layer of the encoding neural network. The group convolution operation includes: performing, in the at least one convolutional layer, grouping on feature maps of the image based on a channel, to obtain a plurality of groups; and performing a convolution operation in each of the plurality of groups, to obtain a group convolution feature of each group, the group convolution feature of each group including a convolution feature of a channel in the group. An output channel in each of the plurality of groups interacts with only an input channel in the group, and is unrelated to a channel in others of the plurality of groups.

In an embodiment, the encoding group convolution indication information is further configured for indicating a quantity of groups in the convolutional layer of the encoding neural network on which the group convolution operation is to be performed.

In an embodiment, the quantity of groups during the group convolution operation indicated by the encoding group convolution indication information is configured to be dynamically adjusted as a network parameter of the convolutional layer of the encoding neural network changes.

In an embodiment, a quantity of the at least one convolutional layer is M, M being a positive integer.

The encoding group convolution indication information is further configured for indicating m convolutional layers of the M convolutional layers in which the group convolution operation is to be performed, m being a positive integer and m being less than or equal to M.

In an embodiment, a selection rule for the m convolutional layers includes at least one of the following:
selecting, in descending order of distances between the M convolutional layers and the output layer, the m convolutional layers in which the group convolution operation is to be performed from the M convolutional layers; and
selecting, in descending order of complexity of network structures, the m convolutional layers in which the group convolution operation is to be performed from the M convolutional layers.

In an embodiment, the encoding group convolution indication information is further configured for indicating a quantity of groups in each of the m convolutional layers on which the group convolution operation is to be performed.

The quantities of groups in different convolutional layers of the m convolutional layers on which the group convolution operation is to be performed are the same or different.

In an embodiment, the encoding simplification operation further includes a channel reconstruction operation; and the encoding indication information includes encoding channel reconstruction indication information, the encoding channel reconstruction indication information being configured for instructing to perform a channel reconstruction operation in the at least one convolutional layer of the encoding neural network. The channel reconstruction operation includes: reordering group convolution features of all groups obtained through the group convolution operation, to obtain reordered group convolution features.

In an embodiment, the encoding channel reconstruction indication information is configured in a network structure of the convolutional layer of the encoding neural network.

In an embodiment, the encoding channel reconstruction indication information is further configured for indicating a quantity of channels and identifiers of channels in the convolutional layer of the encoding neural network on which the channel reconstruction operation is to be performed.

In an embodiment, the quantity of channels during the channel reconstruction operation indicated by the encoding channel reconstruction indication information is configured to be dynamically adjusted as the network parameter of the convolutional layer of the encoding neural network changes.

In an embodiment, one of the at least one convolutional layer includes I channels, and the encoding channel reconstruction indication information is further configured for indicating O channels of the I channels on which the channel reconstruction operation is to be performed, O being a positive integer and O being less than or equal to I.

In an embodiment, a selection rule for the O channels includes at least one of the following:
selecting, based on a rule of reducing a memory resource consumption amount, the O channels on which the channel reconstruction operation is to be performed from the I channels; or
selecting, based on a data communication demand among a plurality of groups during the group convolution operation corresponding to the O channels, the O channels on which the channel reconstruction operation is to be performed from the I channels.

In an embodiment, a quantity of the at least one convolutional layer is M, and the M convolutional layers include m convolutional layers in which the group convolution operation is to be performed, M and m both being positive integers and m being less than or equal to M.

The encoding channel reconstruction indication information is further configured for indicating q convolutional layers of the m convolutional layers on which the channel reconstruction operation is to be performed, q being a positive integer and q being less than or equal to m.

In an embodiment, the encoding group convolution indication information is further configured for indicating a quantity of channels in each of the q convolutional layers on which the channel reconstruction operation is to be performed.

The quantities of channels in different convolutional layers of the q convolutional layers on which the channel reconstruction operation is to be performed are the same or different.

In an embodiment, the encoding neural network includes at least one of the following: an analysis transform net and a hyper encoder net.

The encoding simplification operation includes the group convolution operation. If the encoding indication information indicates that the group convolution operation is to be performed in convolutional layers of all nets, quantities of groups in the convolutional layers of all of the nets on which the group convolution operation is to be performed indicated by the encoding indication information may be the same or different.

The encoding simplification operation further includes the channel reconstruction operation. If the encoding indication information instructs to perform the channel reconstruction operation in the convolutional layers of all of the nets, quantities of channels in the convolutional layers of all of the nets on which the channel reconstruction operation is to be performed indicated by the encoding indication information are the same or different.

In this embodiment of this application, the to-be-processed image is obtained, and the encoding indication information is provided on the encoding device side, the encoding indication information being configured for indicating the encoding simplification operation to be performed in the encoding neural network; and then the encoding neural network is invoked based on the encoding indication information to perform encoding processing on the image, to reconstruct the image. During the encoding of the image, the indication of the encoding indication information can simplify an encoding operation in the encoding neural network on an encoder side, which can effectively reduce encoding complexity on the encoder side, thereby improving encoding efficiency.

An image processing apparatus provided in an embodiment of this application is described below.

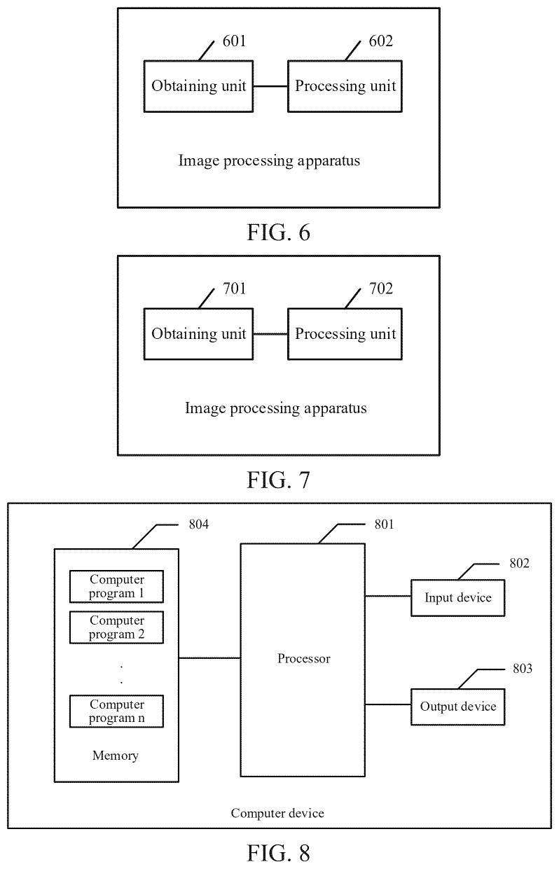

FIG. 6 is a schematic structural diagram of an image processing apparatus according to an embodiment of this application. The image processing apparatus may be a computer program (including program code) in a computing device. For example, the image processing apparatus may be application software in the computing device. The information processing apparatus may be configured to perform some or all of the operations in the method embodiment shown in FIG. 4. Referring to FIG. 6, the image processing apparatus includes the following units:
an obtaining unit 601, configured to obtain a bit stream of an image formed after encoding processing;
the obtaining unit 601 being further configured to obtain decoding indication information, the decoding indication information being configured for indicating a decoding simplification operation to be performed in a decoding neural network, the decoding simplification operation being configured for performing grouping processing on a convolution operation performed in at least one convolutional layer included in the decoding neural network; and
a processing unit 602, configured to invoke, based on the decoding indication information, the decoding neural network to perform the decoding simplification operation to perform decoding processing on the bit stream, to reconstruct the image.

In an embodiment, the decoding simplification operation includes a group convolution operation, and the decoding indication information includes decoding group convolution indication information, the decoding group convolution indication information being configured for instructing to perform the group convolution operation in the at least one convolutional layer of the decoding neural network. The group convolution operation includes: performing, in the at least one convolutional layer, grouping on feature maps of the image based on a channel, to obtain a plurality of groups; and performing a convolution operation in each of the plurality of groups, to obtain a group convolution feature of each group, the group convolution feature of each group including a convolution feature of a channel in the group. An output channel in each of the plurality of groups interacts with only an input channel in the group, and is unrelated to a channel in others of the plurality of groups.

In an embodiment, the decoding group convolution indication information is configured in a network structure of the convolutional layer of the decoding neural network.

In an embodiment, the decoding group convolution indication information is further configured for indicating a quantity of groups during the group convolution operation.

In an embodiment, the quantity of groups during the group convolution operation indicated by the decoding group convolution indication information is configured to be dynamically adjusted as a network parameter of the convolutional layer of the decoding neural network changes.

In an embodiment, a quantity of the at least one convolutional layer of the decoding neural network is N, N being a positive integer.

The decoding group convolution indication information is further configured for indicating n convolutional layers of the N convolutional layers in which the group convolution operation is to be performed, n being a positive integer and n being less than or equal to N.

In an embodiment, a selection rule of n convolutional layers includes at least one of the following:
selecting, in descending order of distances between the N convolutional layers and the output layer, the n convolutional layers in which the group convolution operation is to be performed from the N convolutional layers; and
selecting, in descending order of complexity of network structures, the n convolutional layers in which the group convolution operation is to be performed from the N convolutional layers.

In an embodiment, the decoding group convolution indication information is further configured for indicating a quantity of groups in each of the n convolutional layers on which the group convolution operation is to be performed.

The quantities of groups in different convolutional layers of the n convolutional layers on which the group convolution operation is to be performed are the same or different.

In an embodiment, the decoding simplification operation further includes a channel reconstruction operation; and the decoding indication information includes decoding channel reconstruction indication information, the decoding channel reconstruction indication information being configured for instructing to perform a channel reconstruction operation in the at least one convolutional layer of the decoding neural network. The channel reconstruction operation includes: reordering group convolution features of all groups obtained through the group convolution operation, to obtain reordered group convolution features.

In an embodiment, the decoding channel reconstruction indication information is configured in a network structure of the convolutional layer of the decoding neural network.

In an embodiment, the decoding channel reconstruction indication information is further configured for indicating a quantity of channels and/or identifiers of channels during the channel reconstruction operation.

In an embodiment, the quantity of channels during the channel reconstruction operation indicated by the decoding channel reconstruction indication information is configured to be dynamically adjusted as the network parameter of the convolutional layer of the decoding neural network changes.

In an embodiment, one of the at least one convolutional layer includes P channels. the decoding channel reconstruction indication information is further configured for indicating p channels of the P channels on which the channel reconstruction operation is to be performed, p being a positive integer and p being less than or equal to P.

In an embodiment, a selection rule for the p channels includes at least one of the following:
selecting, based on a rule of reducing a memory resource consumption amount, the p channels on which the channel reconstruction operation is to be performed from the P channels; or
selecting, based on a data communication demand among a plurality of groups during the group convolution operation corresponding to the P channels, the p channels on which the channel reconstruction operation is to be performed from the P channels.

In an embodiment, the quantity of the at least one convolutional layer of the decoding neural network is N, the N convolutional layers including n convolutional layers in which the group convolution operation is to be performed, N and n both being positive integers and n being less than or equal to N.

The decoding channel reconstruction indication information is further configured for indicating t convolutional layers of the n convolutional layers in which the channel reconstruction operation is to be performed, t being a positive integer and t being less than or equal to n.

In an embodiment, the decoding channel reconstruction indication information is further configured for indicating a quantity of channels in each of the t convolutional layers on which the channel reconstruction operation is to be performed.

The quantities of channels in different convolutional layers of the t convolutional layers on which the channel reconstruction operation is to be performed are the same or different.

In an embodiment, the decoding neural network includes at least one of the following: a hyper decoder net, a hyper scale decoder net, and a synthesis transform net, each net including a convolutional layer.

The decoding simplification operation includes the group convolution operation, and if the decoding indication information indicates that the group convolution operation is to be performed in convolutional layers of all nets, quantities of groups in the convolutional layers of all of the nets on which the group convolution operation is to be performed indicated by the decoding indication information are the same or different.

The decoding simplification operation further includes the channel reconstruction operation, and if the decoding indication information instructs to perform the channel reconstruction operation in the convolutional layers of all of the nets, quantities of channels in the convolutional layers of all of the nets on which the channel reconstruction operation is to be performed indicated by the decoding indication information are the same or different.

In an embodiment, the decoding neural network includes a convolutional layer, and the decoding simplification operation includes a group convolution operation and a channel reconstruction operation. The processing unit 601 is specifically configured to:
invoke, based on the decoding indication information, the decoding neural network to perform decoding processing on the bit stream, to obtain a transformation value of the image;
invoke the at least one convolutional layer to perform the group convolution operation on the transformation value of the image, to obtain a group convolution result corresponding to the transformation value of the image;
perform the channel reconstruction operation on the group convolution result, to obtain a channel reconstruction result; and
perform decoding processing on the channel reconstruction result, to reconstruct the image.

In this embodiment of this application, the bit stream of the image formed after encoding processing is obtained, and the decoding indication information is obtained, the decoding indication information being configured for indicating the decoding simplification operation to be performed in the decoding neural network; and then the decoding neural network is invoked based on the decoding indication information to perform decoding processing on the bit stream, to reconstruct the image. During the decoding of the image, the indication of the decoding indication information can simplify a decoding operation in the decoding neural network on a decoder side, which can effectively reduce decoding complexity on the decoder side, thereby improving decoding efficiency.

FIG. 7 is a schematic structural diagram of an image processing apparatus according to an embodiment of this application. The image processing apparatus may be a computer program (including program code) in a computing device. For example, the image processing apparatus may be application software in the computing device. The information processing apparatus may be configured to perform some or all of the operations in the method embodiment shown in FIG. 4. Referring to FIG. 7, the image processing apparatus includes the following units:
an obtaining unit 701, configured to obtain a to-be-processed image,
the obtaining unit 701 is further configured to obtain encoding indication information, the encoding indication information being configured for indicating an encoding simplification operation to be performed in an encoding neural network, the encoding simplification operation being configured for performing grouping processing on a convolution operation performed in at least one convolutional layer included in the encoding neural network; and
a processing unit 702, configured to invoke, based on the encoding indication information, the encoding neural network to perform the encoding simplification operation to perform encoding processing on the image, to obtain a bit stream.

In an embodiment, the encoding simplification operation includes a group convolution operation; and the encoding indication information includes encoding group convolution indication information, the encoding group convolution indication information being configured for instructing to perform the group convolution operation in the at least one convolutional layer of the encoding neural network. The group convolution operation includes: performing, in the at least one convolutional layer, grouping on feature maps of the image based on a channel, to obtain a plurality of groups; and performing a convolution operation in each of the plurality of groups, to obtain a group convolution feature of each group, the group convolution feature of each group including a convolution feature of a channel in the group. An output channel in each of the plurality of groups interacts with only an input channel in the group, and is unrelated to a channel in others of the plurality of groups.

In an embodiment, the encoding group convolution indication information is further configured for indicating a quantity of groups in the convolutional layer of the encoding neural network on which the group convolution operation is to be performed.

In an embodiment, the quantity of groups during the group convolution operation indicated by the encoding group convolution indication information is configured to be dynamically adjusted as a network parameter of the convolutional layer of the encoding neural network changes.

In an embodiment, a quantity of the at least one convolutional layer is M, M being a positive integer.

The encoding group convolution indication information is further configured for indicating m convolutional layers of the M convolutional layers in which the group convolution operation is to be performed, m being a positive integer and m being less than or equal to M.

In an embodiment, a selection rule for the m convolutional layers includes at least one of the following:
selecting, in descending order of distances between the M convolutional layers and the output layer, the m convolutional layers in which the group convolution operation is to be performed from the M convolutional layers; and
selecting, in descending order of complexity of network structures, the m convolutional layers in which the group convolution operation is to be performed from the M convolutional layers.

In an embodiment, the encoding group convolution indication information is further configured for indicating a quantity of groups in each of the m convolutional layers on which the group convolution operation is to be performed.

The quantities of groups in different convolutional layers of the m convolutional layers on which the group convolution operation is to be performed are the same or different.

In an embodiment, the encoding simplification operation further includes a channel reconstruction operation; and the encoding indication information includes encoding channel reconstruction indication information, the encoding channel reconstruction indication information being configured for instructing to perform a channel reconstruction operation in the at least one convolutional layer of the encoding neural network. The channel reconstruction operation includes: reordering group convolution features of all groups obtained through the group convolution operation, to obtain reordered group convolution features.

In an embodiment, the encoding channel reconstruction indication information is configured in a network structure of the convolutional layer of the encoding neural network.

In an embodiment, the encoding channel reconstruction indication information is further configured for indicating a quantity of channels and identifiers of channels in the convolutional layer of the encoding neural network on which the channel reconstruction operation is to be performed.

In an embodiment, the quantity of channels during the channel reconstruction operation indicated by the encoding channel reconstruction indication information is configured to be dynamically adjusted as the network parameter of the convolutional layer of the encoding neural network changes.

In an embodiment, one of the at least one convolutional layer includes I channels, and the encoding channel reconstruction indication information is further configured for indicating O channels of the I channels on which the channel reconstruction operation is to be performed, O being a positive integer and O being less than or equal to I.

In an embodiment, a selection rule for the O channels includes at least one of the following:
selecting, based on a rule of reducing a memory resource consumption amount, the O channels on which the channel reconstruction operation is to be performed from the I channels; or
selecting, based on a data communication demand among a plurality of groups during the group convolution operation corresponding to the O channels, the O channels on which the channel reconstruction operation is to be performed from the I channels.

In an embodiment, a quantity of the at least one convolutional layer is M, and the M convolutional layers include m convolutional layers in which the group convolution operation is to be performed, M and m both being positive integers and m being less than or equal to M.

The encoding channel reconstruction indication information is further configured for indicating q convolutional layers of the m convolutional layers on which the channel reconstruction operation is to be performed, q being a positive integer and q being less than or equal to m.

In an embodiment, the encoding group convolution indication information is further configured for indicating a quantity of channels in each of the q convolutional layers on which the channel reconstruction operation is to be performed.

The quantities of channels in different convolutional layers of the q convolutional layers on which the channel reconstruction operation is to be performed are the same or different.

In an embodiment, the encoding neural network includes at least one of the following: an analysis transform net and a hyper encoder net.

The encoding simplification operation includes the group convolution operation. If the encoding indication information indicates that the group convolution operation is to be performed in convolutional layers of all nets, quantities of groups in the convolutional layers of all of the nets on which the group convolution operation is to be performed indicated by the encoding indication information may be the same or different.

The encoding simplification operation further includes the channel reconstruction operation. If the encoding indication information instructs to perform the channel reconstruction operation in the convolutional layers of all of the nets, quantities of channels in the convolutional layers of all of the nets on which the channel reconstruction operation is to be performed indicated by the encoding indication information are the same or different.

In this embodiment of this application, the to-be-processed image is obtained, and the encoding indication information is provided on the encoding device side, the encoding indication information being configured for indicating the encoding simplification operation to be performed in the encoding neural network; and then the encoding neural network is invoked based on the encoding indication information to perform encoding processing on the image, to reconstruct the image. During the encoding of the image, the indication of the encoding indication information can simplify an encoding operation in the encoding neural network on an encoder side, which can effectively reduce encoding complexity on the encoder side, thereby improving encoding efficiency.

A computer device provided in an embodiment of this application is described below.

Further, an embodiment of this application further provides a schematic structural diagram of a computer device. The schematic structural diagram of the computer device is shown in FIG. 8. The computer device may include a processor 801, an input device 802, an output device 803, and a memory 804. The processor 801, the input device 802, the output device 803, and the memory 804 are connected by a bus. The memory 804 is configured to store a computer program, the computer program including program instructions, and the processor 801 is configured to execute the program instructions stored in the memory 804.

When the computer device is the foregoing decoding device, in this embodiment of this application, the processor 801 performs the following operations by running the program instructions in the memory 804:
obtaining a bit stream of an image formed after encoding processing;
obtaining decoding indication information, the decoding indication information being configured for indicating a decoding simplification operation to be performed in a decoding neural network, the decoding simplification operation being configured for performing grouping processing on a convolution operation performed in at least one convolutional layer included in the decoding neural network; and
invoking, based on the decoding indication information, the decoding neural network to perform the decoding simplification operation to perform decoding processing on the bit stream, to reconstruct the image.

In an embodiment, the decoding simplification operation includes a group convolution operation, and the decoding indication information includes decoding group convolution indication information, the decoding group convolution indication information being configured for instructing to perform the group convolution operation in the at least one convolutional layer of the decoding neural network. The group convolution operation includes: performing, in the at least one convolutional layer, grouping on feature maps of the image based on a channel, to obtain a plurality of groups; and performing a convolution operation in each of the plurality of groups, to obtain a group convolution feature of each group, the group convolution feature of each group including a convolution feature of a channel in the group. An output channel in each of the plurality of groups interacts with only an input channel in the group, and is unrelated to a channel in others of the plurality of groups.

In an embodiment, the decoding group convolution indication information is configured in a network structure of the convolutional layer of the decoding neural network.

In an embodiment, the decoding group convolution indication information is further configured for indicating a quantity of groups during the group convolution operation.

In an embodiment, the quantity of groups during the group convolution operation indicated by the decoding group convolution indication information is configured to be dynamically adjusted as a network parameter of the convolutional layer of the decoding neural network changes.

In an embodiment, a quantity of the at least one convolutional layer of the decoding neural network is N, N being a positive integer.

The decoding group convolution indication information is further configured for indicating n convolutional layers of the N convolutional layers in which the group convolution operation is to be performed, n being a positive integer and n being less than or equal to N.

In an embodiment, a selection rule of n convolutional layers includes at least one of the following:
selecting, in descending order of distances between the N convolutional layers and the output layer, the n convolutional layers in which the group convolution operation is to be performed from the N convolutional layers; and
selecting, in descending order of complexity of network structures, the n convolutional layers in which the group convolution operation is to be performed from the N convolutional layers.

In an embodiment, the decoding group convolution indication information is further configured for indicating a quantity of groups in each of the n convolutional layers on which the group convolution operation is to be performed.

The quantities of groups in different convolutional layers of the n convolutional layers on which the group convolution operation is to be performed are the same or different.

In an embodiment, the decoding simplification operation further includes a channel reconstruction operation; and the decoding indication information includes decoding channel reconstruction indication information, the decoding channel reconstruction indication information being configured for instructing to perform a channel reconstruction operation in the at least one convolutional layer of the decoding neural network. The channel reconstruction operation includes: reordering group convolution features of all groups obtained through the group convolution operation, to obtain reordered group convolution features.

In an embodiment, the decoding channel reconstruction indication information is configured in a network structure of the convolutional layer of the decoding neural network.

In an embodiment, the decoding channel reconstruction indication information is further configured for indicating a quantity of channels and/or identifiers of channels during the channel reconstruction operation.

In an embodiment, the quantity of channels during the channel reconstruction operation indicated by the decoding channel reconstruction indication information is configured to be dynamically adjusted as the network parameter of the convolutional layer of the decoding neural network changes.

In an embodiment, a convolutional layer of the at least one convolutional layer includes P channels; and the decoding channel reconstruction indication information is further configured for indicating p channels of the P channels on which the channel reconstruction operation is to be performed, p being a positive integer and p being less than or equal to P.

In an embodiment, a selection rule for the p channels includes at least one of the following:
selecting, based on a rule of reducing a memory resource consumption amount, the p channels on which the channel reconstruction operation is to be performed from the P channels; or
selecting, based on a data communication demand among a plurality of groups during the group convolution operation corresponding to the P channels, the p channels on which the channel reconstruction operation is to be performed from the P channels.

In an embodiment, the quantity of the at least one convolutional layer of the decoding neural network is N, the N convolutional layers including n convolutional layers in which the group convolution operation is to be performed, N and n both being positive integers and n being less than or equal to N.

The decoding channel reconstruction indication information is further configured for indicating t convolutional layers of the n convolutional layers in which the channel reconstruction operation is to be performed, t being a positive integer and t being less than or equal to n.

In an embodiment, the decoding channel reconstruction indication information is further configured for indicating a quantity of channels in each of the t convolutional layers on which the channel reconstruction operation is to be performed.

The quantities of channels in different convolutional layers of the t convolutional layers on which the channel reconstruction operation is to be performed are the same or different.

In an embodiment, the decoding neural network includes at least one of the following: a hyper decoder net, a hyper scale decoder net, and a synthesis transform net, each net including a convolutional layer.

The decoding simplification operation includes the group convolution operation, and if the decoding indication information indicates that the group convolution operation is to be performed in convolutional layers of all nets, quantities of groups in the convolutional layers of all of the nets on which the group convolution operation is to be performed indicated by the decoding indication information are the same or different.

The decoding simplification operation further includes the channel reconstruction operation, and if the decoding indication information instructs to perform the channel reconstruction operation in the convolutional layers of all of the nets, quantities of channels in the convolutional layers of all of the nets on which the channel reconstruction operation is to be performed indicated by the decoding indication information are the same or different.

In an embodiment, the decoding neural network includes at least one convolutional layer, and the decoding simplification operation includes a group convolution operation and a channel reconstruction operation, when invoking, based on the decoding indication information, the decoding neural network to perform decoding processing on the bit stream, to reconstruct the image, the processor 801 may specifically perform the following operations:
invoking, based on the decoding indication information, the decoding neural network to perform decoding processing on the bit stream, to obtain a transformation value of the image;
invoking the at least one convolutional layer to perform the group convolution operation on the transformation value of the image, to obtain a group convolution result corresponding to the transformation value of the image;
performing the channel reconstruction operation on the group convolution result, to obtain a channel reconstruction result; and
performing decoding processing on the channel reconstruction result, to reconstruct the image.

In this embodiment of this application, the bit stream of the image formed after encoding processing is obtained, and the decoding indication information is obtained, the decoding indication information being configured for indicating the decoding simplification operation to be performed in the decoding neural network; and then the decoding neural network is invoked based on the decoding indication information to perform decoding processing on the bit stream, to reconstruct the image. During the decoding of the image, the indication of the decoding indication information can simplify a decoding operation in the decoding neural network on a decoder side, which can effectively reduce decoding complexity on the decoder side, thereby improving decoding efficiency.

In some embodiments, when the computer device is the foregoing encoding device, in this embodiment of this application, the processor 801 performs the following operations by running the program instructions in the memory 804:
obtaining a to-be-processed image;
obtaining encoding indication information, the encoding indication information being configured for indicating an encoding simplification operation to be performed in an encoding neural network, the encoding simplification operation being configured for performing grouping processing on a convolution operation performed in at least one convolutional layer included in the encoding neural network; and
invoking, based on the encoding indication information, the encoding neural network to perform the encoding simplification operation to perform encoding processing on the image, to obtain a bit stream.

In this embodiment of this application, the to-be-processed image is obtained, and the encoding indication information is provided on the encoding device side, the encoding indication information being configured for indicating the encoding simplification operation to be performed in the encoding neural network; and then the encoding neural network is invoked based on the encoding indication information to perform encoding processing on the image, to reconstruct the image. During the encoding of the image, the indication of the encoding indication information can simplify an encoding operation in the encoding neural network on an encoder side, which can effectively reduce encoding complexity on the encoder side, thereby improving encoding efficiency.

In addition, an embodiment of this application further provides a non-transitory computer-readable storage medium, the computer-readable storage medium having a computer program stored therein, the computer program including program instructions. When a processor executes the program instructions, the methods in the foregoing embodiments corresponding to FIG. 4 and FIG. 5 may be performed. Details are not described herein. For technical details that are not disclosed in the embodiment of the computer-readable storage medium included in this application, reference may be made to the descriptions of the method embodiments of this application. In an example, the program instructions may be deployed to be executed on a computer device, or deployed to be executed on a plurality of computer devices at the same location, or deployed to be executed on a plurality of computer devices that are distributed in a plurality of locations and interconnected by using a communication network.

According to an aspect of this application, a computer program product is provided, the computer program product including a computer program, the computer program being stored in a non-transitory computer-readable storage medium. A processor of a computer device reads the computer program from the computer-readable storage medium, and executes the computer program, so that the computer device can perform the methods in the embodiments corresponding to FIG. 4 and FIG. 5. Details are not described herein.

A person of ordinary skill in the art may understand that all or some of the processes of the methods of the foregoing embodiments may be implemented by a computer program instructing relevant hardware. The program may be stored in a non-transitory computer-readable storage medium. When the program is executed, the processes of the foregoing method embodiments may be implemented. The storage medium may include a magnetic disc, an optical disc, a read-only memory (ROM), a random access memory (RAM), or the like.

In this application, the term “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit can be implemented using one or more processors (or processors and memory). Likewise, a processor (or processors and memory) can be used to implement one or more units. Moreover, each unit can be part of an overall unit that includes the functionalities of the unit. What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. An image processing method, comprising:
obtaining a bit stream of an image;
extracting, from the bit stream, decoding indication information, the decoding indication information indicating a decoding operation to be performed in a decoding neural network; and
invoking, based on the decoding indication information, a decoding neural network to perform the decoding operation on the bit stream to reconstruct the image, wherein the decoding operation is configured for performing grouping on a convolution operation in at least one convolutional layer in the decoding neural network.

2. The method according to claim 1, wherein the decoding operation comprises a group convolution operation, and the decoding indication information comprises decoding group convolution indication information, the decoding group convolution indication information being configured for instructing to perform a group convolution operation in the at least one convolutional layer of the decoding neural network; and
the group convolution operation comprises:
performing, in the at least one convolutional layer, grouping on feature maps of the image based on a channel, to obtain a plurality of groups; and
performing a convolution operation in each of the plurality of groups, to obtain a group convolution feature of each group, the group convolution feature of each group comprising a convolution feature of a channel in the group.

3. The method according to claim 2, wherein an output channel in each of the plurality of groups interacts with only an input channel in the group, and is unrelated to a channel in others of the plurality of groups.

4. The method according to claim 2, wherein the decoding group convolution indication information is further configured for indicating a quantity of groups during the group convolution operation.

5. The method according to claim 4, wherein the quantity of groups during the group convolution operation indicated by the decoding group convolution indication information is configured to be dynamically adjusted as a network parameter of the convolutional layer of the decoding neural network changes.

6. The method according to claim 2, wherein a quantity of the at least one convolutional layer of the decoding neural network is N, N being a positive integer; and
the decoding group convolution indication information is further configured for indicating n convolutional layers of the N convolutional layers in which the group convolution operation is to be performed, n being a positive integer and n being less than or equal to N.

7. The method according to claim 6, wherein a selection rule for the n convolutional layers comprises at least one of the following:
selecting, in descending order of distances between the N convolutional layers and the output layer, the n convolutional layers in which the group convolution operation is to be performed from the N convolutional layers; and
selecting, in descending order of complexity of network structures, the n convolutional layers in which the group convolution operation is to be performed from the N convolutional layers.

8. The method according to claim 6, wherein the decoding group convolution indication information is further configured for indicating a quantity of groups in each of the n convolutional layers on which the group convolution operation is to be performed; and
the quantities of groups in different convolutional layers of the n convolutional layers on which the group convolution operation is to be performed are the same or different.

9. The method according to claim 2, wherein the decoding operation further comprises a channel reconstruction operation, and the decoding indication information comprises decoding channel reconstruction indication information, the decoding channel reconstruction indication information being configured for instructing to perform a channel reconstruction operation in the at least one convolutional layer of the decoding neural network, the channel reconstruction operation comprising:
reordering group convolution features of all groups obtained through the group convolution operation, to obtain reordered group convolution features.

10. The method according to claim 9, wherein the decoding group convolution indication information and/or the decoding channel reconstruction indication information is configured in a network structure of the convolutional layer of the decoding neural network.

11. The method according to claim 9, wherein the decoding channel reconstruction indication information is further configured for indicating a quantity of channels and/or identifiers of channels during the channel reconstruction operation.

12. The method according to claim 11, wherein the quantity of channels during the channel reconstruction operation indicated by the decoding channel reconstruction indication information is configured to be dynamically adjusted as the network parameter of the convolutional layer of the decoding neural network changes.

13. The method according to claim 9, wherein one of the at least one convolutional layer comprises P channels, and the decoding channel reconstruction indication information is further configured for indicating p channels of the P channels on which the channel reconstruction operation is to be performed, p being a positive integer and p being less than or equal to P.

14. The method according to claim 13, wherein a selection rule for the p channels comprises at least one of the following:
selecting, based on a rule of reducing a memory resource consumption amount, the p channels on which the channel reconstruction operation is to be performed from the P channels; or
selecting, based on a data communication demand among a plurality of groups during the group convolution operation corresponding to the P channels, the p channels on which the channel reconstruction operation is to be performed from the P channels.

15. The method according to claim 9, wherein the quantity of the at least one convolutional layer of the decoding neural network is N, the N convolutional layers comprising n convolutional layers in which the group convolution operation is to be performed, N and n both being positive integers and n being less than or equal to N; and
the decoding channel reconstruction indication information is further configured for indicating t convolutional layers of the n convolutional layers in which the channel reconstruction operation is to be performed, t being a positive integer and t being less than or equal to n.

16. The method according to claim 15, wherein the decoding channel reconstruction indication information is further configured for indicating a quantity of channels in each of the t convolutional layers on which the channel reconstruction operation is to be performed; and
the quantities of channels in different convolutional layers of the t convolutional layers on which the channel reconstruction operation is to be performed are the same or different.

17. The method according to claim 1, wherein the decoding neural network comprises at least one of the following: a hyper decoder net, a hyper scale decoder net, and a synthesis transform net, each net comprising a convolutional layer;
the decoding operation comprises the group convolution operation, and if the decoding indication information indicates that the group convolution operation is to be performed in convolutional layers of all nets, quantities of groups in the convolutional layers of all of the nets on which the group convolution operation is to be performed indicated by the decoding indication information are the same or different; and
the decoding operation further comprises the channel reconstruction operation, and if the decoding indication information instructs to perform the channel reconstruction operation in the convolutional layers of all of the nets, quantities of channels in the convolutional layers of all of the nets on which the channel reconstruction operation is to be performed indicated by the decoding indication information are the same or different.

18. A computer device, comprising:
a processor, configured to execute a computer program; and
a computer-readable storage medium, having a computer program stored therein, the computer program, when executed by the processor, causing the computer device to perform an image processing method including:
obtaining a bit stream of an image;
extracting, from the bit stream, decoding indication information, the decoding indication information indicating a decoding operation to be performed in a decoding neural network; and
invoking, based on the decoding indication information, a decoding neural network to perform the decoding operation on the bit stream to reconstruct the image, wherein the decoding operation is configured for performing grouping on a convolution operation in at least one convolutional layer in the decoding neural network.

19. The computer device according to claim 18, wherein the decoding operation comprises a group convolution operation, and the decoding indication information comprises decoding group convolution indication information, the decoding group convolution indication information being configured for instructing to perform a group convolution operation in the at least one convolutional layer of the decoding neural network; and
the group convolution operation comprises:
performing, in the at least one convolutional layer, grouping on feature maps of the image based on a channel, to obtain a plurality of groups; and
performing a convolution operation in each of the plurality of groups, to obtain a group convolution feature of each group, the group convolution feature of each group comprising a convolution feature of a channel in the group.

20. A non-transitory computer-readable storage medium, having a computer program stored therein, the computer program, when executed by a processor of a computer device, causing the computer device to perform an image processing method including:
obtaining a bit stream of an image;
extracting, from the bit stream, decoding indication information, the decoding indication information indicating a decoding operation to be performed in a decoding neural network; and
invoking, based on the decoding indication information, a decoding neural network to perform the decoding operation on the bit stream to reconstruct the image, wherein the decoding operation is configured for performing grouping on a convolution operation in at least one convolutional layer in the decoding neural network.
